(19) United States
(12) Patent Application Publication
(10) Pub. No.: US 2026/0238550 A1
(43) Pub. Date: Aug. 13, 2026

(54) UNIVERSAL DEVICE IDENTIFICATION FRAMEWORK FOR A MULTI-SOURCE COMPUTING PLATFORM

(71) Applicant: Chime Financial, Inc., San Francisco, CA (US)

(72) Inventors: Ryan Bahniuk, Chicago, IL (US); Varun Rai, Milpitas, CA (US); Charles Roland Kirk, Chicago, IL (US); Lace Cheung, San Francisco, CA (US)

(21) Appl. No.: 19/053,241

(22) Filed: Feb. 13, 2025

(51) Int. Cl. H04L 41/12; H04L 41/16

(52) U.S. Cl. CPC H04L 41/12; H04L 41/16; H04L 45/02; H04L 67/51; H04L 2101/30

(57) ABSTRACT

The present disclosure relates to systems, non-transitory computer-readable media, and methods for registering client devices using universal device identifications that aggregate identification attributes from multiple sources into a composite device profile specific to each client device. For example, in one or more embodiments, the disclosed systems utilize a device identification system of an inter-network facilitation system to receive an interaction with an application on an unrecognized client device. Furthermore, in response to receiving the interaction, the disclosed systems extract device attributes for the unrecognized client device. Moreover, in some embodiments, the disclosed systems utilize a device identification model of the device identification system to compare current device attributes with stored device attributes for universal device identifications maintained within the device identification system. Based on the comparison, the device identification system determines a universal device identification for the unrecognized client device.

### BRIEF DESCRIPTION OF THE DRAWINGS

The detailed description provides one or more embodiments with additional specificity and detail through the use of the accompanying drawings, as briefly described below.

FIG. 1 illustrates an overview diagram of a device identification system interacting with a client device based utilizing a universal device identification in accordance with one or more embodiments.

FIG. 2 illustrates an example diagram of a device identification system integrating with an inter-network facilitation system 120 utilizing universal device identifications in accordance with one or more embodiments.

FIG. 3 illustrates an example diagram of aggregating various device attributes for a universal device identification in accordance with one or more embodiments.

FIG. 4 illustrates an example diagram of the device identification system registering a client device utilizing a universal device identification in accordance with one or more embodiments.

FIG. 5 illustrates an example flowchart of the device identification system utilizing a cascaded identification model to select one or more attribute extractor(s) to extract device attributes for a universal device identification in accordance with one or more embodiments.

FIG. 6 illustrates an example flowchart of the device identification system utilizing a machine learning model to determine a universal device identification for a client device in accordance with one or more embodiments.

FIG. 7 illustrates an example of training a machine learning device identification model to predict identification scores for universal device identifications in accordance with one or more embodiments.

FIG. 8A illustrates an example graphical user interface of the device identification system providing device insights for a network graph utilizing universal device identifications in accordance with one or more embodiments.

FIG. 8B illustrates an example graphical user interface of the device identification system providing a network graph to manage client devices in accordance with one or more embodiments.

FIG. 9 illustrates a block diagram of an environment for implementing a device identification system in accordance with one or more embodiments.

FIG. 10 illustrates an example series of acts for determining a universal device identification for an unrecognized client device in accordance with one or more embodiments.

FIG. 11 illustrates a block diagram of a computing device for implementing one or more embodiments of the present disclosure.

FIG. 12 illustrates an example environment for the device identification system in accordance with one or more embodiments.

### DETAILED DESCRIPTION

This disclosure describes one or more embodiments of a device identification system 100 that receives a digital interaction with a client device and causes a device identification service to register the client device by associating the client device with a universal device identification which integrates identification attributes into a composite device profile specific to the client device. For example, the device identification system 100 receives an interaction from an unrecognized client device (e.g., a device unassociated with the system and/or not recognized from a previous digital interaction). In response to receiving the interaction, the device identification system 100 can extract device attributes for the client device. Moreover, in some embodiments, the device identification system 100 compares the device attributes with stored device attributes defining universal device identifications maintained within a data depository of the device identification system 100. Based on the comparison, the device identification system 100 can determine a universal device identification for the unrecognized client device.

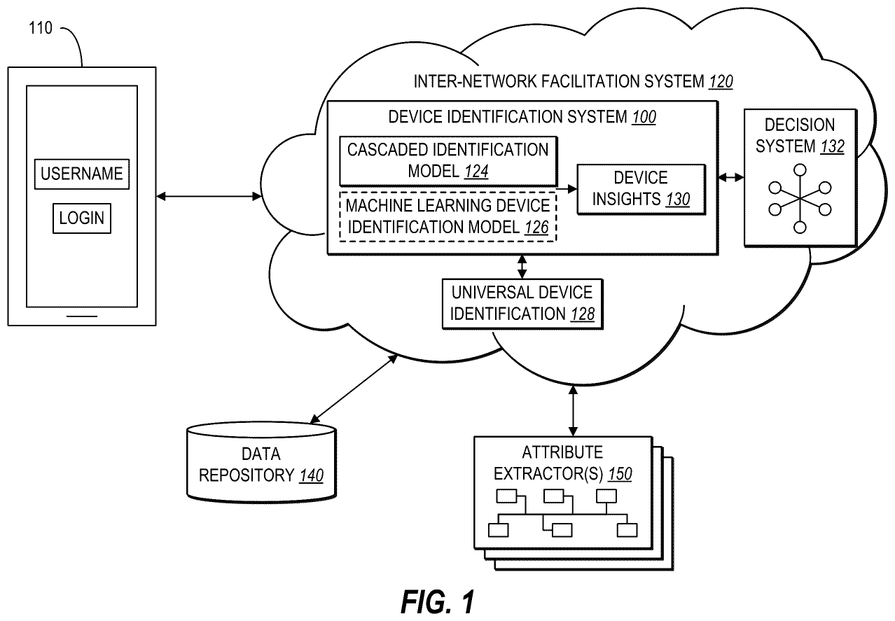

As shown in FIG. 1, the device identification system 100 receives an interaction from a client device 110. In one or more embodiments, the client device 110 refers to a computing device that accesses services and functions of the device identification system 100, and more broadly the services and functions of an inter-network facilitation system 120. In some cases, the client device 110 is an unrecognized client device. For example, the client device 110 can include an unrecognized client device that has not previously interacted with, or that is not registered with (or under a user account within), the device identification system 100 and/or the inter-network facilitation system 120. In some cases, an unrecognized client device includes a client device 110 that the device identification system 100 considers to be an unrecognized client device until the device identification system 100 identifies the client device 110 as a device associated with a universal device identification 128.

As shown in FIG. 1, the device identification system 100 generates the universal device identification 128 for the client device 110. As used herein, the universal device identification 128 includes or refers to a standardized identification or definition of a client device (e.g., the client device 110). The device identification system 100 can use a particular method or system for generating a universal device identification to uniquely identify client devices (e.g., the client device 110) across different platforms, networks, and environments. A universal device identification can include, or be made up of, a set of device attributes (e.g., a device manufacturer, a device model, and/or other device attributes). As used herein, device attributes can include or refer to specific characteristics, properties, or identifiers associated with a client device. For example, device attributes can be associated with client device hardware, device software, network settings (including Bluetooth configuration, Wi-Fi configuration), device identifiers, GPS data, biometric sensors, power metrics, peripheral connections, device storage capacity, device memory capacity, device chip set, or device usage patterns for the client device.

Utilizing the universal device identification 128, the device identification system 100 can create a globally (e.g., across the inter-network facilitation system 120) recognizable and consistent identifier to distinguish the client device 110 from other client devices, regardless of device updates, operating system changes, network changes, entry-point variation (e.g., accessing via mobile applications or web browser interfaces), or other environmental elements. In some cases, the device identification system 100 generates a new universal device identification (e.g., the universal device identification 128) for an unrecognized client device (e.g., client device 110). In some cases, the device identification system 100 associates an unrecognized client device (e.g., client device 110) with an existing universal device identification (e.g., the universal device identification 128). In some cases, the device identification system 100 can store the universal device identification 128 within the data repository 140.

As further shown in FIG. 1, the device identification system 100 utilizes one or more device identification models to select attribute extractor(s) 150 and determine the universal device identification 128 for the client device 110. In one or more embodiments, a device identification model includes or refers to a systematic approach, framework, or algorithm employed by the device identification system 100 to uniquely identify the client device 110 based on device attributes and/or device interactions with the inter-network facilitation system 120. Using the device identification model(s), the device identification system 100 identifies the client device 110 independent of software, networks, platforms, or systems.

As shown in FIG. 1, in some cases, the device identification system 100 utilizes a cascaded identification model 124 as the device identification model. As used herein, the cascaded identification model 124 includes or refers to a cascaded selection framework for employing the attribute extractor(s) 150. For example, the device identification system 100 utilizes the cascaded identification model 124 to select the attribute extractor(s) 150 to, in a cascaded approach, extract device attributes for the client device 110 and determine the universal device identification 128 uniquely associated with the client device 110. For instance, the cascaded identification model 124 extracts (using a first attribute extractor) a first set of device attributes on a first pass (or at a first iteration), determines whether a threshold confidence is satisfied for determining a universal device identification for a client device based on the extracted device attributes, and cascades down to a subsequent attribute extractor if the threshold confidence is not satisfied. The cascading continues from one attribute extractor to the next, extracting one or more additional device attributes at each cascade level, until the threshold confidence is satisfied and the device identification system 100 assigns a universal device identification.

For example, the cascaded identification model 124 performs a systematic selection from among the attribute extractor(s) 150 to select one or more of the attribute extractor(s) 150 to extract device attributes for the client device 110. In some cases, the cascaded identification model 124 evaluates the attribute extractor(s) 150 in sequence to select one or more of the attribute extractor(s) 150. In some cases, the cascaded identification model 124 selects one or more of the attribute extractor(s) 150 based on previously extracted device attributes for the client device 110 (e.g., missing attributes, outdated attributes). In some cases, the cascaded identification model 124 is a self-actuating model that evaluates criteria or conditions and adjusts the selection of one or more of the attribute extractor(s) 150. To illustrate, the cascade model can remove one or more of the attribute extractor(s) 150 from the selection process (e.g., for a time period or based on threshold values) or end the cascaded selection when a specific outcome is achieved (e.g., a particular attribute is extracted for the client device 110).

In some embodiments, the device identification system 100 utilizes a machine learning device identification model 126 as a device identification model. As used herein, the machine learning device identification model 126 includes or refers to a machine learning model such as a computer algorithm or a collection of computer algorithms that can be trained and/or tuned to associate the client device 110 with the universal device identification 128. In some cases, the device identification system 100 employs the machine learning device identification model 126 as a specially trained machine learning model to process client device identification data (e.g., device attributes, historical device attributes, potential universal device identifications, etc.). In some embodiments, the device identification system 100 utilizes the machine learning device identification model 126 to generate identification scores for potential universal device identifications for the client device 110. Based on comparing the identification scores to a threshold score, the device identification system 100 determines the universal device identification 128 for the client device 110.

In some embodiments, the inter-network facilitation system 120 utilizes the device identification system 100 as an application layer between a decision system 132 within the inter-network facilitation system 120 and the client device 110. For example, the device identification system 100 obtains identification data from the client device 110 (e.g., client generated identification, device attributes, device metadata) to associate a universal device identification 128 with the client device 110. Furthermore, the inter-network facilitation system 120 utilizes the device identification system 100 to register the client device 110 and provide device insights 130 for the client device 110 utilizing the universal device identification 128. For example, the device identification system 100 generates the device insights 130 which include data to identify and evaluate the trustworthiness of the client device 110 (e.g., device trust levels, network graphs, ground truth data). In turn, the decision system 132 utilizes the universal device identification 128 and the device insights 130 from the device identification system 100 to inform actions regarding the client device 110, such as making decisions regarding executing network transactions initiated by the client device 110.

Existing systems suffer from a number of technical deficiencies when it comes to authorizing network access, particularly with regard to accuracy and data security. For example, existing systems often inaccurately authorize network access (or performance of network transactions) for client devices. Some existing systems inaccurately identify devices in part due to the inconsistency of identification attributes involved in the authorization or identification process across different platforms or subsystems of an overall network environment. For instance, under the authorization techniques of many existing systems, identification attributes used to identify a device vary significantly between a mobile application and a web browser, making it difficult for existing systems to reliably recognize the same device accessing the network through multiple interfaces.

Compounding the inaccuracies of existing systems, the dynamic nature of client device attributes (e.g., due to software or hardware updates) often results in further identification errors. For example, updates to client devices can alter identifiers like operating system versions or application configurations, leading existing systems to misidentify the client devices. To illustrate, existing systems often misidentify a device that undergoes a routine operating system update as a new device, resulting in unnecessary alerts or flagging legitimate transactions as suspicious. This instability in device recognition also increases the computational burden on existing systems, consuming additional computational resources and time to resolve client device identities through added steps and processes that could be avoided with a more accurate system.

Relatedly, in network transaction ecosystems, many existing systems use client device identity assessing risk and evaluating transaction legitimacy. However, due at least in part to their inaccuracies, many existing systems are insecure. For instance, some systems compromise data security due to an inability to reliability and accurately identify client devices accessing and performing transaction in network environments. Consequently, malicious actors can mimic legitimate client device identifiers, misleading existing systems into incorrectly associating fraudulent interactions with trusted client devices. This susceptibility to incorrect device identification creates a significant security vulnerability, enabling malicious actors to evade detection and potentially access user accounts, sensitive information, or private data (e.g., financial account data).

As suggested above, the device identification system 100 provides several improvements or advantages over existing systems. For example, the device identification system 100 provides improved accuracy over existing systems. As discussed, existing systems often misidentify client devices due to differing approaches which consider different device parameters across platforms (e.g., web browsers and mobile apps) and/or due to dynamic changes in identification parameters due to hardware and software updates. In contrast, the device identification system 100 utilizes a universal device identification to reliably identify client devices, regardless of entry-point platform, configuration, or dynamic attribute changes (even across application sessions). For example, even if the device hardware or software changes (e.g., software updates and/or device reconfiguration), the device identification system 100 can still accurately associate client devices with prior client device interactions using universal device identifications.

Furthermore, by utilizing server-generated and hardware-based universal device identifications (as opposed to software-generated identifications), the device identification system 100 avoids inconsistencies prevalent in prior systems. Unlike existing approaches that rely on single or isolated data points provided by the client device (e.g., MAC addresses, IP addresses, or other software-generated attributes), the device identification system 100 utilizes the universal device identification which is based on hardware attributes of a device. In some cases, the device identification system 100 can utilize universal device identifications to incorporate client device attributes such as device hardware, device software, network configuration, device behavioral patterns, geolocation, and fingerprint data. By relying on hardware features (and/or by aggregating client device attributes from multiple sources), the device identification system 100 can create a robust device identifier that reduces the likelihood of misidentification and/or inconsistencies compared to existing systems.

The device identification system 100 also offers significant data security advantages over existing financial transaction systems. For example, through the use of a universal device identification, the device identification system 100 more reliably identifies devices accessing and performing transactions within a networking environment. For example, using the universal device identification, the device identification system 100 can use hardware-based and/or server-generated device attributes to reliably identify client devices, thereby reducing data breaches and fraudulent transactions, either accidentally or from malicious actors. Because the universal device identification is server-generated with attributes garnered from multiple device interactions utilizing a variety of attribute extractors, the device identification system 100 provides a comprehensive identify of a device that is resistant to spoofing, duplication, or unauthorized modification. For example, a malicious device attempting to mimic a client device would need to replicate exact device hardware and/or other device attributes, adding significant improvements in security over circumventing the isolated data points of some existing systems.

Relatedly, by linking (or basing) access to the inter-network facilitation system 120 to a universal device identification, the device identification system 100 can integrate with the inter-network facilitation system 120 to provide additional security measures. For example, the inter-network facilitation system 120 can enforce access (or execution of network transactions) for client devices based on a verified association between user credentials and a recognized physical device (e.g. verified using a universal device identification). Furthermore, by correlating device data from multiple device interactions with the inter-network facilitation system 120, the device identification system 100 is able to generate device insights such as device trust levels and network graphs to more accurately identify legitimate client devices. For example, the inter-network facilitation system 120 can facilitate targeted device interactions based on the trust levels for client devices (e.g., blacklist devices, adjust authentication friction, restrict access). Additionally, the device identification system 100 can detect multiple devices accessing the same login account and assign device trust levels based on the consistency of the device attributes (e.g., universal device identifications) to generate device insights for risk decisioning and fraud prevention.

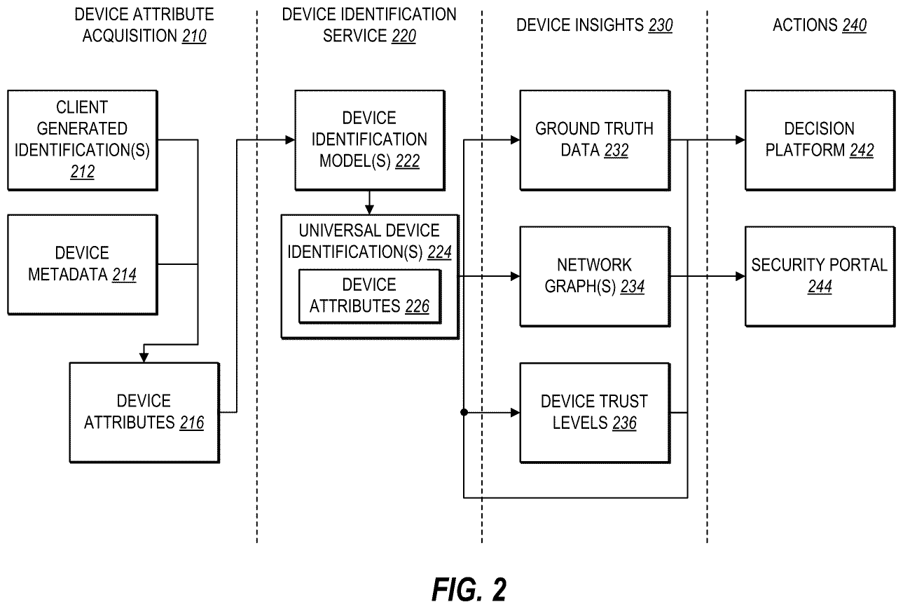

As mentioned, the device identification system 100 integrates with an inter-network facilitation system 120 to provide device insights and associate universal device identifications with client devices. In particular, the device identification system 100 integrates with an inter-network facilitation system 120 that executes network transactions, such as a transfer of assets from one digital account to another (e.g., within a shared platform or across servers of different platforms), a deposit into a digital account, a withdrawal from a digital account, a credit check on a digital account, or a purchase made by a digital account. FIG. 2 illustrates an example diagram of the device identification system integrating with an inter-network facilitation system 120 in accordance with one or more embodiments.

As shown in FIG. 2, the device identification system 100 performs a device attribute acquisition 210 for a client device interacting with the inter-network facilitation system 120. As used herein, device attributes 216 include or refer to specific characteristics, properties, or identifiers associated with client devices. For example, device attributes can be associated with client device hardware, device software, network settings (including Bluetooth configuration, Wi-Fi configuration), device identifiers, GPS data, biometric sensors, power metrics, peripheral connections, device storage capacity, device memory capacity, device chip set, or device usage patterns for the client device.

In some cases, the device identification system 100 extracts, based on an interaction of a client device, device attributes 216 for the client device. For example, the device identification system 100 extracts the device attributes 216 such as client generated identification(s) 212 and device metadata 214. Furthermore, in some cases, the device identification system 100 employs multiple attribute extractors to extract the device attributes 216 from the client device. In turn, the device identification system 100 provides the device attributes 216 extracted by the attribute extractor(s) to the device identification service 220 (for use by the device identification model(s) 222).

In some embodiments, the device identification system 100 extracts the client generated identification(s) 212 for client devices. For example, the device identification system 100 integrates with a client device application on the client device to capture one or more of the device attributes 216. In some cases, the client generated identification(s) 212 can include device attributes 216 such as a mobile app version, a user agent, device storage capacity, device memory capacity, device chip set, screen width, and screen height. In some cases, the client generated identification(s) 212 include a device identifier specific to a client device application that is generated at the time of the application install and stored on the client device. Examples of a client device application include a mobile application, desktop web, mobile web, or mobile application Web View.

In some embodiments, the device identification system 100 extracts the device metadata 214 as one or more of the device attributes 216. For example, the device identification system 100 extracts the device metadata 214 including platform data (e.g., iOS, Android, browser), device data (e.g., advertising ID (generated by OS), extractor ID (generated by OS), network carrier, device manufacturer, device model, OS name, OS version, IP address, battery), browser data (e.g., name, version, user agent, language, time zone) connection data (e.g., IP address, IP version, connection type, line speed, routing type, network carrier, ASN, SIM country code, VPN, proxy, ISP), geolocation IP data (e.g., city, state, country, ZIP, latitude, longitude, DMA code, area code, continent, region, time zone), network settings (including Bluetooth configuration, Wi-Fi configuration), device identifiers, GPS data (e.g., latitude, longitude, altitude, movement speed, movement history), biometric sensors (e.g., fingerprint scans, facial recognition data), power metrics (e.g., charge level, power consumption rates), media usage (e.g., streaming data, audio/visual playback details), peripheral connections (e.g., USB devices, external display, docking station), device storage (e.g., capacity, file types, file access, cloud synchronization), device memory (e.g., capacity, RAM size, RAM usage), and device chip set (e.g., processor type, number of cores, clock speed, manufacturer).

As further shown in FIG. 2, the device identification system 100 includes a device identification service 220 for client devices interacting with the inter-network facilitation system 120. In some embodiments, the device identification system 100 utilizes the device identification service 220 to implement a set of procedures and/or device identification models to integrate device attributes into a consistent structure using universal device identifications. In some embodiments, the device identification service 220 utilizes server-generated universal device identifications to persist the device attributes in a centrally stored data repository.

As mentioned, the device identification system 100 utilizes the device identification model(s) 222 to employ attribute extractor(s) to extract the device attributes 216 for client devices (e.g., cascaded identification model, machine learning device identification model). For example, the device identification service 220 can utilize a cascaded identification model to extract (using a first attribute extractor) a first set of the device attributes 216 based on a client device interaction. When utilizing the cascaded identification model, the device identification service 220 continues to select additional attribute extractors in a cascade, extracting one or more additional sets of the device attributes 216 at each cascade level, until a threshold confidence is satisfied and the device identification service 220 assigns the universal device identification(s) 224 to the client device. In some embodiments, the device identification service 220 utilizes a machine learning device identification model as the device identification model(s) 222. When utilizing the machine learning device identification model, the device identification service 220 determines the universal device identification(s) 224 for the client device by generating and comparing identification scores for the universal device identification(s) 224 to a threshold score.

In some embodiments, the device identification system 100 utilizes the device identification model(s) 222 to aggregate device attributes 226 (e.g., including client generated identification(s) 212, device attributes 216, and device metadata 214) and generate the universal device identification(s) 224. For example, the device identification system 100 utilizes the device identification model(s) 222 to select attribute extractors and obtain the device attributes 226 for client devices that interact with the inter-network facilitation system 120. By aggregating the device attributes 226 (e.g., current and historical attributes) within the universal device identification(s) 224, the device identification system 100 utilizes the device identification model(s) 222 to identify the client device 110 independent of software, networks, platforms, or systems.

As further shown in FIG. 2, the device identification system 100 generates device insights 230 utilizing the universal device identification(s) 224. For example, the device identification system 100 generates events for client device interactions with the inter-network facilitation system 120 and records the client device interactions (e.g., logins and transaction requests) in a data repository. Furthermore, the device identification system 100 generates events for state changes to device attributes of the universal device identification(s) 224 including recording the device state changes in the data repository. In turn, based on the interaction data and the state changes, the device identification system 100 utilizes the universal device identification(s) 224 to generate device insights to improve the accuracy of client device identification over time. In some cases, the device identification system 100 records state changes including:

Device_Created, Registration_Created, Registration_Status_Updated,
Registration_CompositeStatus_Updated, Device_UsageStatus_Updated,
Device_Association_Status_Changed, Extractor_Request (HTTP request),
Extractor_Response(HTTP response).

In some embodiments, the device identification system 100 generates ground truth data 232 for training machine learning models utilizing the universal device identification(s) 224. For example, the device identification system 100 utilizes the stored device interactions and stored device state changes to accumulate a comprehensive dataset of device attributes for training machine learning models. The device identification system 100 can use the device attributes as input to a machine learning model (e.g., a multivariate regression model for device identification).

In some embodiments, the device identification system 100 utilizes the universal device identification(s) 224, cookies, and/or user feedback to generate the ground truth data 232. For example, the device identification system 100 filters client device interactions to retain only the client device interactions associated with a universal device identification. To illustrate, if the universal device identification for a mobile device remains the consistent across device interactions, the device identification system 100 attributes the device interactions to the same device. In some cases, the device identification system 100 filters client device interactions to retain only the client device interactions with validated cookies. To illustrate, by filtering the device attributes to only include device attributes that remain consistent across device interactions with the same cookie, the device identification system 100 retains the verifiable device interactions for a client device as the ground truth data 232. Furthermore, in some cases, the device identification system 100 can utilize user feedback to validate and refine the ground truth data 232. To illustrate, by requesting user confirmation of changes to device attributes (e.g., software updates, new hardware), the device identification system 100 can validate potential device attributes for the ground truth data 232.

In some embodiments, the device identification system 100 generates network graph(s) 234 utilizing the universal device identification(s) 224. In some embodiments, the device identification system 100 generates the network graph(s) 234 as graphical structure(s) to represent the relationships or interactions between entities. For example, the device identification system 100 generates nodes to indicate entities such as client devices, user accounts, or IP addresses and edges to indicate interactions/relationships such as authentication values, device-user relationships, device-IP relationships. To illustrate, the device identification system 100 can provide the network graph(s) 234 to the inter-network facilitation system 120 to represent relationships corresponding to unauthorized usage or compromised client devices. The device identification system 100 provides the device insights 230 of the network graph(s) 234 to enhance the security of the inter-network facilitation system 120, enabling administrator devices to proactively block security threats from compromised client devices and ensure the integrity of the inter-network facilitation system 120.

In some embodiments, the device identification system 100 generates device trust levels 236 to classify client devices based on a device risk level (e.g., device trust score, primary/secondary device, known/new device, authorization status). For example, the device identification system 100 generates a numerical or categorical metric that represents the level of trustworthiness associated with a client device interacting with the inter-network facilitation system 120. In some embodiments, the device identification system 100 generates the device trust levels 236 by utilizing the universal device identification(s) 224 to analyze device attributes, historical interactions, and risk signals. For example, the device identification system 100 can generate, or re-generate, trust levels regularly to reflect current device behavior and historical interactions based on new client device interactions and updated universal device identification(s) 224. By utilizing the universal device identification(s) 224, the device identification system 100 derives the device trust levels from a combination of factors, such as hardware details, network configurations, behavioral patterns, geolocation, and historical activity. Furthermore, the device identification system 100 can provide the device trust levels 236 to the inter-network facilitation system 120 to facilitate actions such as access control, fraud prevention, multi-factor authentication, network security, and/or user experience optimization.

In one or more embodiments, the device identification system 100 can provide the device trust levels 236 utilizing a risk hierarchy. For example, the device identification system 100 can provide the device trust levels 236 to facilitate regulation of authorized actions when the device trust levels 236 meets a required threshold. In some cases, the device identification system 100 can provide the device trust levels 236 to the inter-network facilitation system 120 to classify the client device at a first (e.g., below a threshold) trust level to facilitate access to lower-risk actions such as accessing non-sensitive data, interacting with public-facing features, or performing routine actions that pose minimal risk to security or privacy. In some cases, the device identification system 100 can provide the device trust levels 236 to the inter-network facilitation system 120 to classify the client device at a second (e.g., at or above the threshold) trust level to facilitate access to higher-risk actions such as initiating financial transactions, accessing sensitive personal or corporate data, or modifying system-critical settings.

As further shown in FIG. 2, the device identification system 100 provides the universal device identification(s) 224 and the device insights 230 to enable actions 240 for a decision system 242 and/or a security portal 244. For example, the device identification system 100 provides the universal device identification(s) 224 the decision system 242 and/or the security portal 244 correlate client devices with historical interactions and behavioral patterns (e.g., to facilitate consistent device recognition across platforms over time). In some cases, the device identification system 100 provides the ground truth data 232 to facilitate the training of machine learning models and establish baselines for normal client device behavior. In certain cases, the device identification system 100 provides the network graph(s) 234 to facilitate anomaly detection for device interactions, highlight patterns of unauthorized access, and/or inform management of interactions with client devices. In some embodiments, the device identification system 100 provides the device trust levels 236 to the decision system 242 and/or the security portal 244 to facilitate risk decisioning and security measures for the client devices.

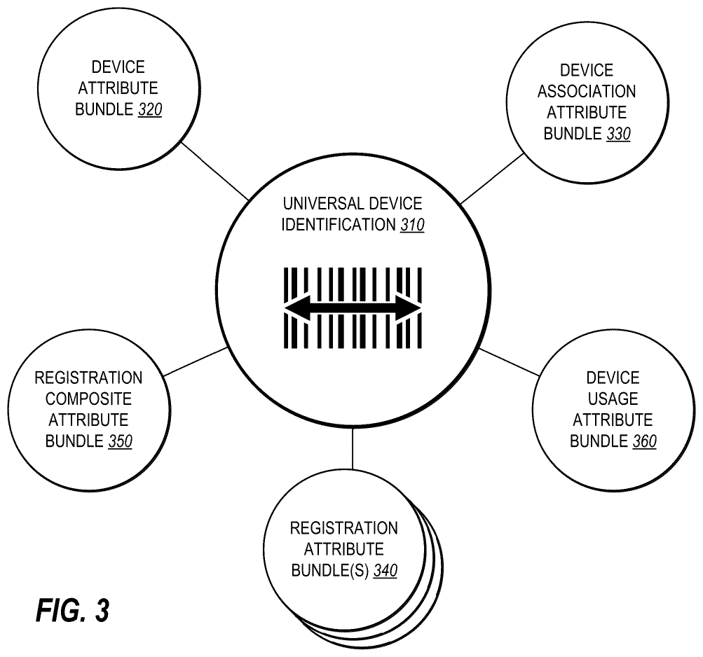

As mentioned, the device identification system 100 generates universal device identifications to provide a consistent, standardized, and reliable way to uniquely identify client devices across different environments, platforms, and interactions. FIG. 3 illustrates an example diagram of aggregating various device attributes for a universal device identification in accordance with one or more embodiments.

As shown in FIG. 3, some embodiments of the device identification system 100 utilize attribute bundles to aggregate related device attributes of a universal device identification 310. As shown, the universal device identification 310 aggregates the attribute bundles to provide a structured compilation of the device attributes associated with a client device. In particular, the device identification system 100 stores the attributes extracted utilizing the attribute extractors organized within the attributes among the attribute bundles. By bundling related attributes extracted by the attribute extractors, the device identification system 100 facilitates efficient processing and management of related device attributes. In some cases, the device identification system 100 utilizes attribute bundles such as a device attribute bundle 320, a device association attribute bundle 330, registration attribute bundle(s) 340, a registration composite attribute bundle 350, and/or a device usage attribute bundle 360.

In one or more embodiments, the device identification system 100 generates a device attribute bundle 320 associated with the universal device identification 310. The device identification system 100 utilizes the device attribute bundle 320 as a canonical device to uniquely represent client devices within the inter-network facilitation system 120. In some embodiments, the device identification system 100 utilizes the device attribute bundle 320 similar to the following:

Device
Attribute Bundle

| | |
|---|---|
| id | A unique universal device identification value |
| | for the client device |
| manufacturer | Manufacturer name |
| model | Model name |
| created_at | Time of first interaction with the client device |

To illustrate, utilizing the device attribute bundle 320, the device identification system 100 can generate the universal device identification 310 with a unique universal device identification value associated with each client device. In some embodiments, the device identification system 100 generates the device attribute bundle 320 which includes a manufacturer identification matching the device manufacturer and a model identification matching the device model of the unrecognized client device.

In one or more embodiments, the device identification system 100 utilizes the manufacturer identification and the model identification to verify the identity of the client device for the universal device identification 310. For example, the device identification system 100 can utilize the manufacturer identification and the model identification of the device attribute bundle 320 to determine the universal device identification 310 is associated with the client device with a threshold confidence. To illustrate, the device identification system 100 can determine an identification score for the client device based on comparing the manufacturer identification and the model identification extracted using an attribute extractor with the stored manufacturer identification and the stored model identification within the device attribute bundle 320. In this way, the device identification system 100 utilizes attributes (e.g., manufacturer and model) that cannot evolve over time for a singular piece of hardware to uniquely associate the client device with the universal device identification 310.

In some cases, the device identification system 100 generates a device association attribute bundle 330 associated with the universal device identification 310. The device identification system 100 utilizes the device association attribute bundle 330 to associate fingerprints for attribute extractors with the universal device identification 310. In some embodiments, the device identification system 100 utilizes the device association attribute bundle 330 such as the following:

Device Association
Attribute Bundle

| | |
|---|---|
| id | A unique identifier for this instance of a Device |
| | Association Attribute Bundle |
| device_id | The unique universal device identification |
| | value for the client device |
| extractor_id | The client generated identification provided by |
| | the client device/application |
| attribute_extractor_id# | Attribute extractor device fingerprint - linked to |
| | account data and user history data. The device |
| | identification system 100 can utilize multiple |
| | attribute_extractor_id# (based on the number |
| | of attribute extractors). |
| created_at | When the Device Association Attribute Bundle |
| | was first created |

To illustrate, the device identification system 100 device identification system 100 can incorporate a variety of device attributes from different sources into the universal device identification 310 utilizing the device association attribute bundle 330. For example, the device identification system 100 can incorporate a set of client device generated attributes (e.g., associated with “device_id”) that can vary based upon the device and/or platform (e.g., iOS, Android, web app, Web View). Furthermore, utilizing the device association attribute bundle 330, the device identification system 100 can generate a universal device identification 310 by aggregating a first set of device attributes from a first attribute extractor (e.g., using attribute_extractor_id1) and a second set of device attributes from a second attribute extractor (e.g., using attribute_extractor_id2).

In some embodiments, the device identification system 100 generates the registration attribute bundle(s) 340 associated with the universal device identification 310. The device identification system 100 utilizes the registration attribute bundle(s) 340 to record the registration of a client device. The device identification system 100 generates a registration attribute bundle(s) 340 at every app/website open. In some embodiments, the device identification system 100 utilizes multiple instances of the registration attribute bundle(s) 340 for each universal device identification 310. In some embodiments, the device identification system 100 utilizes the registration attribute bundle(s) 340 such as the following:

Registration
Attribute Bundle

| | |
|---|---|
| id | A unique identifier for this instance of a Registration Bundle |
| device_id | The unique universal device identification value for the |
| | client device |
| session_id | The public ID of the AuthN session record - will be null |
| | if the client device is not actively logged-in |
| request_id | The nginx generated request ID of the registration request |
| platform | Device Platform |
| analytics_session_id | The correlation ID for events published inside of a single |
| | app-open session |
| fingerprint_data | A bundle of fingerprints for the client device. 1-to-1 with |
| | Registration Attribute Bundle, 1-to-many with Device |
| | Attribute Bundle |
| app_data | A bundle of mobile app data for the client device. 0-to-1 |
| | with Registration Attribute Bundle, 1-to-many with |
| | Device Attribute Bundle. Includes app version, |
| | Advertising ID, and Extractor ID. |
| browser_data | A bundle of web browser related data for the client device. |
| | 0-to-1 with Registration Attribute Bundle, 1-to-many with |
| | Device Attribute Bundle. Only persisted for browsers. |
| os_data | A bundle of operating system related data for the client |
| | device. 1-to-1 with Registration Attribute Bundle, 1-to- |
| | many with Device Attribute Bundle. Includes OS data, |
| | language, time zone, and platform map. |
| connection_data | A bundle of data for how the client device connected. 1- |
| | to-1 with Registration Attribute Bundle, 1-to-many with |
| | Device Attribute Bundle, 1-to-1 with geo_ip_data. |
| | Includes IP address, line speed, ASN. |
| geo_ip_data | Geo IP location data. 1-to-1 with connection_data |
| | associated by IP address. |
| created_at | When the Registration Attribute Bundle was created |
| updated_at | When the registration was last updated - utilized for |
| | adding attributes asynchronously |

In one or more embodiments, the device identification system 100 generates a registration composite attribute bundle 350 associated with the universal device identification 310. The device identification system 100 utilizes the registration composite attribute bundle 350 to record the most recently seen device attributes for the client device. For example, the device identification system 100 generates a registration composite attribute bundle 350 by merging the attributes of the registration attribute bundle(s) 340. In some embodiments, the device identification system 100 utilizes the registration composite attribute bundle 350 such as the following:

Registration
Composite Bundle

| | |
|---|---|
| id | A unique identifier for this instance of a Registration Bundle |
| device_id | The unique universal device identification value for the |
| | client device |
| session_id | The public ID of the AuthN session record - will be null |
| | if the client device is not actively logged-in |
| request_id | The nginx generated request ID of the registration request |
| platform | Device Platform |
| analytics_session_id | The correlation ID for events published inside of a single |
| | app-open session |
| fingerprint_data | A bundle of fingerprints for the client device. 1-to-1 with |
| | Registration Attribute Bundle, 1-to-many with Device |
| | Attribute Bundle |
| app_data | A bundle of mobile app data for the client device. 0-to-1 |
| | with Registration Attribute Bundle, 1-to-many with |
| | Device Attribute Bundle. Includes app version, |
| | Advertising ID, and Extractor ID. |
| browser_data | A bundle of web browser related data for the client device. |
| | 0-to-1 with Registration Attribute Bundle, 1-to-many with |
| | Device Attribute Bundle. Only persisted for browsers. |
| os_data | A bundle of operating system related data for the client |
| | device. 1-to-1 with Registration Attribute Bundle, 1-to- |
| | many with Device Attribute Bundle. Includes OS data, |
| | language, time zone, and platform map. |
| connection_data | A bundle of data for how the client device connected. 1- |
| | to-1 with Registration Attribute Bundle, 1-to-many with |
| | Device Attribute Bundle, 1-to-1 with geo_ip_data. |
| | Includes IP address, line speed, ASN. |
| geo_ip_data | Geo IP location data. 1-to-1 with connection_data |
| | associated by IP address. |
| created_at | Time of first interaction with the client device |
| updated_at | Time of most recent interaction with the client device |

In one or more embodiments, the device identification system 100 generates a device usage attribute bundle 360 for the universal device identification 310. The device identification system 100 utilizes the device usage attribute bundle 360 to associate client devices with user accounts. In some embodiments, the device identification system 100 utilizes the device usage attribute bundle 360 such as the following:

Device Usage
Attribute Bundle

| | |
|---|---|
| id | A unique identifier for this instance of a Registration |
| | Composite Bundle |
| device_id | The unique universal device identification value |
| | for the client device |
| user_id | The user account ID of the user record |
| authenticated | Boolean of whether the usage was successfully |
| | logged in |
| first_seen_at | When the user account first used the client device - |
| | regardless of authenticated status |
| last_seen_at | When the user account last used the client device - |
| | regardless of authenticated status |

To illustrate, the device identification system 100 device identification system 100 can utilize the device usage attribute bundle 360 to monitor the usage of client devices. For example, the device identification system 100 can utilize the device usage attribute bundle 360 to determine usage such as the last used device for a user account, the first used device for a user account, when a device was used by a user account, the device used for a given session of a user account, or all devices used by a user account within a time period.

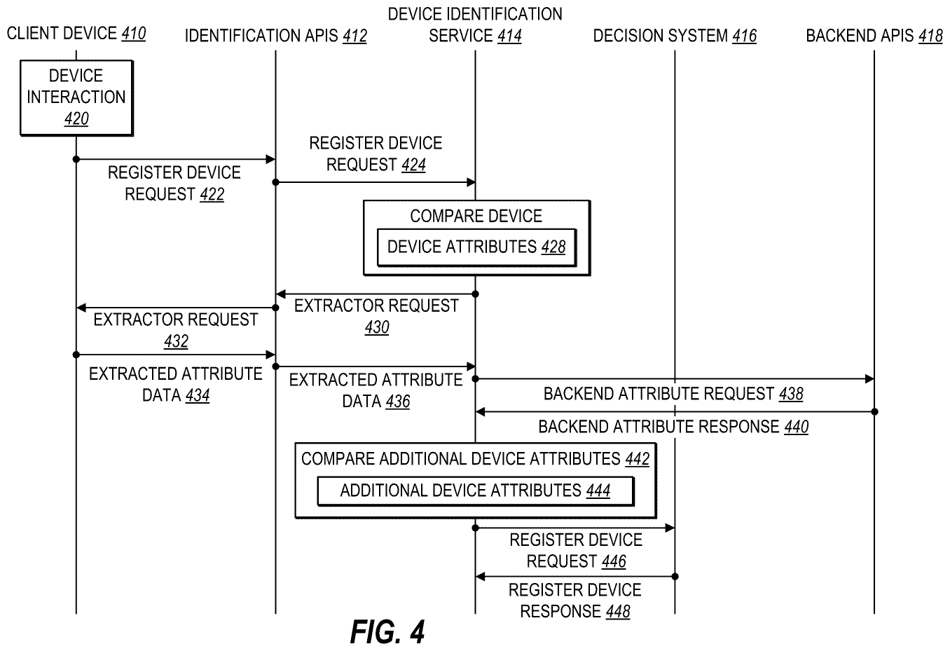

As mentioned, the device identification system 100 registers client devices utilizing universal device identifications. FIG. 4 illustrates an example diagram of the device identification system 100 registering a client device utilizing a universal device identification in accordance with one or more embodiments.

As illustrated by FIG. 4, a client device 410 performs a device interaction 420. For example, the device interaction 420 includes a user account interaction with an application on the client device 410 which triggers an event (e.g., register device request 422). In some cases, the device interaction 420 includes a failed login attempt from the client device 410, an authenticated login attempt from the client device 410, interaction within an application on the client device 410, or another type of interaction from the client device 410.

Based on the device interaction 420, the client device 410 provides a register device request 422 to identification APIs 412. Furthermore, the identification APIs 412 provide a register device request 424 to the device identification service 414. In certain embodiments, the device identification service 414 extracts the device attributes 428 for the client device 410 from the register device request 424. For example, the device identification service 414 extracts the device attributes 428 of a device manufacturer (e.g., manufacturer identification) and a device model (e.g., model identification) for the client device 410 from the register device request 424. In some cases, the device identification service 414 extracts the device attributes 428 from the register device request 424 such as the client generated identification(s) 212, device attributes 216, and the device metadata 214 as described in relation to FIG. 2.

For example, the device identification service 414 can extract the device attributes 428 from the register device request 424 including a client generated identification from a client device application (e.g., attributes associated with the client application and stored on the client device). In some cases, the client generated identification includes device attributes 428 such as a mobile application version, user agent, screen width, and screen height. Furthermore, the device identification service 414 can extract the device attributes 428 from the register device request 424 including device metadata and device usage attributes. In some cases the device metadata and device usage attributes include platform data (e.g., iOS, Android, browser), device data (e.g., advertising ID (generated by OS), extractor ID (generated by OS), network carrier, device manufacturer, device model, OS name, OS version, IP address, battery), browser data (e.g., name, version, user agent, language, time zone) connection data (e.g., IP address, IP version, connection type, line speed, routing type, network carrier, ASN, SIM country code, VPN, proxy, ISP), and geo IP data (e.g., city, state, country, ZIP, latitude, longitude, DMA code, area code, continent, region, time zone).

As shown in FIG. 4, the device identification service 414 performs an act 426 to compare device attributes. For example, the device identification service 414 determines a universal device identification for the client device 410 based on comparing the device attributes 428 with stored device attributes for universal device identifications. In some cases, the device identification system 100 utilizes the device manufacturer and the device model to verify the identity of the client device 410. For example, the device identification system 100 can determine a confidence (e.g., utilizing an identification score) that the client device 410 is associated with a universal device identification based on comparing the device manufacturer and the device model for the client device 410 with the model identification and manufacturer identification of the universal device identification. In this way, the device identification system 100 utilizes attributes (e.g., device manufacturer, device model) that do not evolve over time for a singular piece of hardware to uniquely associate the client device 410 with the universal device identification.

In some cases, the device identification service 414 determines identification scores associated with the client device 410 based on comparing additional device attributes with the stored device attributes for the universal device identification. For example, the device identification system 100 utilizes the one or more of the device attributes 428 extracted from the register device request 424 to generate identification scores and verify the identity of the client device 410 based on comparisons of the additional device attributes to attributes of the universal device identifications. Based on determining the identification scores satisfy a threshold score, the device identification service 414 determines a universal device identification for the client device 410.

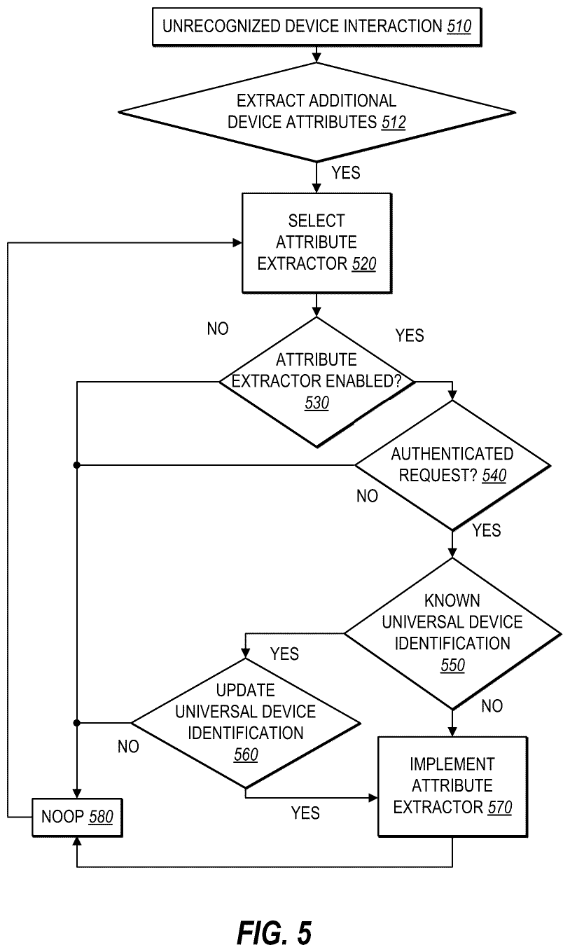

As illustrated by FIG. 4, in some cases, the device identification service 414 determines to update the universal device identification associated with the client device 410. In some cases, the device identification service 414 fails to determine (or determines without meeting a threshold confidence) a universal device identification for the client device 410 based on comparing the device attributes 428 with stored device attributes for universal device identifications. For example, the device identification service 414 determines the client device 410 is not associated with an existing universal device identification based on comparing one or more of the device attributes 428 with the stored device attributes for the universal device identifications. In certain embodiments, based on determining the client device 410 is not associated with an existing universal device identification, the device identification service 414 extracts additional device attributes 444 for the unrecognized client device using one or more attribute extractors. In some cases, the device identification service 414 utilizes a cascaded device identification model or a machine learning device intelligence model to perform act 426 to compare device attributes (e.g., the device attributes 428 and the additional device attributes 444) as discussed in more detail in relation to FIGS. 5-7.

In one or more embodiments, the device identification service 414 utilizes identification scores generated by comparing one or more of the device attributes 428 with the stored device attributes for the universal device identifications. For example, the device identification service 414 determines identification scores associated with the client device 410 based on comparing one or more of the device attributes 428 with the stored device attributes for the universal device identifications. In some cases, based on determining the identification scores fail to satisfy a threshold score, the device identification service 414 determines the client device 410 is not associated with an existing universal device identification and determines to extract the additional device attributes 444 for the client device 410. In some cases, based on determining the identification scores satisfy a threshold score, the device identification service 414 determines the client device 410 is associated with an existing universal device identification and determines to not to extract the additional device attributes 444 for the client device 410.

In some cases, even where the identification scores satisfy a threshold score or the client device 410 is associated with an existing universal device identification, the device identification service 414 determines to extract the additional device attributes 444. For example, the device identification service 414 can determine to extract the additional device attributes 444 to update the universal device identification associated with the client device 410. To illustrate, the device identification service 414 can determine to extract the additional device attributes 444 to update the universal device identification based on a device attribute retention timeframe, security requirements, system configuration, and/or system need (as described in relation to FIG. 5).

In cases where the device identification service 414 determines to extract the additional device attributes 444 for the client device 410, the client device 410 provides an extractor request 430 to the identification APIs 412. Furthermore, the identification APIs 412 provide an extractor request 432 to the client device 410. In some cases, the extractor request 430 and the extractor request 432 include requests to utilize one or more attribute extractors (e.g., software development kits (SDKs)) to extract additional device attributes from the client device 410. In some embodiments, the extractor request 430 and the extractor request 432 include a set of SDKs to initialize on the client device 410.

Based on the extracted attributes, the attribute extractor(s) provide extracted attribute data 434 to the backend APIs 418. Furthermore, the backend APIs 418 provide extracted attribute data 436 to the device identification service 414.

In some cases, based on the extracted attribute data 436, the device identification service 414 communicates with backend APIs 418 to determine and/or refine the additional device attributes 444. For example, device identification service 414 can determine the extracted attribute data 436 is unstructured, encrypted, or incomplete. By providing a backend attribute request 438 to the backend APIs associated with the attribute extractor(s) and receiving a backend attribute response 440, the device identification service 414 receives device attribute data for the additional device attributes 444 in a useable format. In some embodiments, the device identification service 414 performs data munging (e.g., cleaning, reformatting, de-duping, organizing) on the data received from the backend attribute response 440 to determine the additional device attributes 444.

As shown in FIG. 4, the device identification service 414 performs an act 442 to compare additional device attributes. For example, the device identification service 414 determines a universal device identification for the client device 410 based on comparing the additional device attributes 444 with the stored device attributes for universal device identifications. In some cases, the device identification service 414 determines additional identification scores associated with the client device 410 based on comparing one or more of the additional device attributes 444 with the stored device attributes for the universal device identifications. Based on determining the additional identification scores satisfy the threshold score, the device identification service 414 determines a universal device identification for the client device 410.

In certain embodiments, the device identification system 100 repeats the extractor request 430 to extract the further device attributes from the client device 410. For example, based on comparing the additional device attributes 444 with stored device attributes for the universal device identifications, the device identification service 414 can determine to repeat the extractor request 430. In particular, the device identification system 100 can instigate one or more of the extractor request 430, the extractor request 432, the extracted attribute data 434, the extracted attribute data 436, the backend attribute request 438, the backend attribute response 440, and/or the act 442 to repeatedly determine the additional device attributes 444.

As further shown in FIG. 4, the device identification system 100 can coordinate with a decision system 416 to manage certain actions based on the device interaction 420 and the universal device identifications. For example, the device identification service 414 can send a register device request 446 to the decision system 416 to determine whether to generate a new universal device identification for the client device 410. In some cases, the device identification service 414 can include the device attributes 428 and/or the additional device attributes 444 in the register device request 446, and/or existing device attributes (e.g., universal device identifications) in the register device request 446. Based on the register device request 446, the decision system 416 can provide a register device response 448 which includes an indication to generate a new universal device identification associated with the client device 410 or associate an existing universal device identification with the client device 410.

For example, the decision system 416 can coordinate with the device identification service 414 to determine if the device attributes 428 and/or the additional device attributes 444 correspond to an existing universal device identification. To illustrate, the decision system 416 can determine that new application installs on the client device 410 are associated with an existing universal device identification. As another example, the decision system 416 can determine that restoring a backup of an application for a user on a new device model is a new client device and requires a new universal device identification.

As mentioned, in one or more embodiments, the device identification system 100 utilizes a cascaded identification model to determine universal device identifications. FIG. 5 illustrates an example flowchart of the device identification system utilizing a cascaded identification model to extract attributes for a universal device identification in accordance with one or more embodiments.

As illustrated in FIG. 5, the device identification system 100 receives an unrecognized device interaction 510 from a client device. For example, the device identification system 100 receives the unrecognized device interaction 510 such as an interaction with a client device not previously identified or associated with a universal device identification by the device identification system 100. Based on the unrecognized device interaction 510, the device identification system 100 attempts to associate the client device with an existing universal device identification to establish the client device as trusted and/or known within the inter-network facilitation system 120.

To associate client device with an existing universal device identification, upon receiving the unrecognized device interaction 510, the device identification system 100 can perform an act 512 to determine whether to extract additional device attributes. For example, as described above in relation to FIG. 4, the device identification system 100 can receive the unrecognized device interaction 510 via a register device request. Based on the register device request, the device identification system 100 can perform the act 512 to determine whether to extract additional device attributes for the client device. As mentioned, the device identification system 100 can determine to extract additional device attributes (and perform act 520) for the client device based on a variety of factors and even with a threshold confidence the client device is associated with an existing universal device identification. For example, the device identification system 100 can determine to extract additional device attributes based on a confidence threshold, a device attribute retention timeframe, security requirements, system configuration, and/or system need.

Based on the extracted device attributes, in some cases, the device identification system 100 determines to extract additional device attributes utilizing one or more attribute extractors. In particular, the device identification system 100 can perform the act 520 to select one or more attribute extractors. For each attribute extractor of a set of available attribute extractors, the device identification system 100 selects the attribute extractor and implements the flowchart actions as shown in FIG. 5.

As further illustrated in FIG. 5, the device identification system 100 performs a check 530 to determine if the attribute extractor selected in the act 520 is enabled. For example, the device identification system 100 may enable only certain attribute extractors. In some cases, the device identification system 100 enables certain attribute extractors based on a specific time frame (e.g., once every 7 or 14 days per device). In some cases, the device identification system 100 enables certain attribute extractors based on logic such as the following algorithm:

start[Start Lookup] --> deviceIdLookup[Lookup device by dev]
deviceIdLookup -- No --> extractorIdLookup[by extractor_?Id]
extractor_IdLookup -- No --> extractor_1IdLookup[by extractor_1_device_id]
extractor_1IdLookup -- No --> extractor_2IdLookup[by extractor_2_device_id]
extractor_2IdLookup -- No --> returnNull[Return null]
deviceIdLookup -- Yes --> makeModel1[Make/model match reque
extractorIdLookup -- Yes --> makeModel2[Make/model match?]
extractor_1IdLookup -- Yes --> makeModel3[Make/model match?]
extractor_2IdLookup -- Yes --> makeModel4[Make/model match?]
makeModel1 -- No --> extractorIdLookup
makeModel2 -- No --> extractor_1IdLookup
makeModel3 -- No --> extractor_2IdLookup
makeModel4 -- No --> returnNull
makeModel1 -- Yes --> returnDevice[Return device]
makeModel2 -- Yes --> returnDevice[Return device]
makeModel3 -- Yes --> returnDevice[Return device]
makeModel4 -- Yes --> returnDevice[Return device]

If the device identification system 100 determines the selected attribute extractor is enabled, the device identification system 100 performs a check 540 to determine if the unrecognized device interaction 510 corresponds to an authenticated request from a user account. If the unrecognized device interaction 510 does not correspond to an authenticated request from a user account, the device identification system 100 performs a noop action 580 (e.g., does not change the system state or output). If the unrecognized device interaction 510 corresponds to an authenticated request for a user account, the device identification system 100 performs a check 550 to determine if the unrecognized device interaction 510 corresponds to a known universal device identification.

To illustrate, as described above in relation to FIG. 4, the device identification system 100 can perform the check 550 to compare device attributes extracted from the unrecognized device interaction 510 with the universal device identifications to determine if the client device is associated with a known universal device identification. In addition, the device identification system 100 determines identification score(s) for the client device by associating the device attribute(s) with stored device attribute(s) of the universal device identifications. Furthermore, the device identification system 100 determines whether the identification scores satisfy threshold scores indicating with at least a threshold confidence that the client device is associated with an existing universal device identification (e.g., the client device has previously accessed the inter-network facilitation system 120).

As shown in FIG. 5, if the device identification system 100 determines the universal device identification is associated with an existing universal device identification, the device identification system 100 performs a check 560 to determine whether to update the device attributes of the associated universal device identification. In some embodiments, the device identification system 100 implements various types of the check 560 such as a data integrity check (e.g., evaluates whether updating the device attributes will create inconsistencies), a resource optimization check (e.g., evaluates whether the update process is efficient in terms of computational, storage, and network resources), application stability check (e.g., evaluates whether updating the device attributes will negatively impact the stability or functionality of dependent applications or services), attribute type check (e.g., evaluates whether the device attributes are eligible or relevant for modification), extraction complexity check (e.g., evaluates whether extracting and updating the device attributes involves manageable complexity), and/or application compatibility check (e.g., evaluates whether the universal device identification attributes will remain compatible with connected systems, applications, and APIs.

As also shown in FIG. 5, the device identification system 100 performs an act 570 to implement the attribute extractor. For example, if the device identification system 100 determines to update the universal device identification for the client device based on the check 560, the device identification system 100 implements the attribute extractor. Alternatively, if the device identification system 100 does not associate the client device with an existing universal device identification based on the check 560, the device identification system 100 implements the attribute extractor. The device identification system 100 can select one or more attribute extractors to implement by including the attribute extractor in the extractor request 432 (e.g., as discussed in relation to FIG. 4).

As further shown in FIG. 5, in some cases, the device identification system 100 determines to extract additional device attributes utilizing one or more additional attribute extractors. For example, after completing the act 570, the device identification system 100 can perform the noop action 580 and subsequently perform the act 520 to select an additional attribute extractor. In particular, for each attribute extractor of a set of available attribute extractors, the device identification system 100 can repeat the actions described above to select the attribute extractor with the act 520 and implement the subsequent actions associated with the selected attribute extractor as shown in FIG. 5.

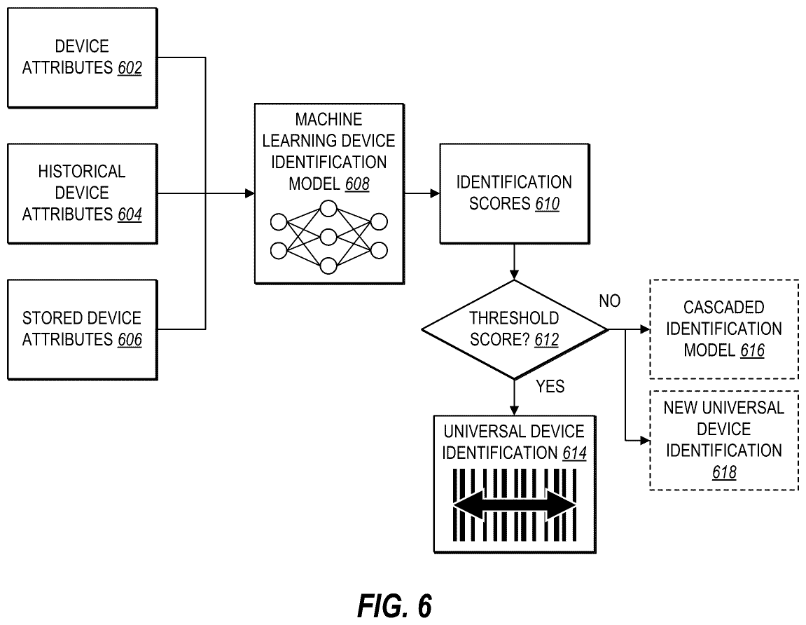

As mentioned, in one or more embodiments, the device identification system 100 utilizes a machine learning model to determine a universal device identification associated with a client device. FIG. 6 illustrates an example flowchart of the device identification system utilizing a machine learning model to determine a universal device identification for a client device in accordance with one or more embodiments. As shown in FIG. 6, the device identification system 100 utilizes the machine learning device identification model 608 to determine the universal device identification 614 for the unrecognized client device based on the device attributes 602, historical device attributes 604, and stored device attributes 606 (e.g., universal device identifications).

As mentioned above, the device identification system 100 extracts the device attributes 602 for an unrecognized client device. In some cases, the device identification system 100 generates a set of identification scores associated with the unrecognized client device based on comparing the device attributes with stored device attributes of universal device identifications. In some embodiments, based on determining that the set of identification scores fail to satisfy a threshold score, the device identification system 100 utilizes a machine learning device identification model 608 to determine a universal device identification 614.

In one or more embodiments, the device identification system 100 generates the historical device attributes 604 by accumulating a dataset for client device interactions over time. For example, the device identification system 100 can continuously generate and store client device interaction data, logging events for client device interactions. Over time, the device identification system 100 accumulates a vast dataset containing various device attributes (e.g., operating system, geolocation, network configuration).

In one or more embodiments, the device identification system 100 generates and stores the historical device attributes 604 based on the attribute type. In some embodiments, the device identification system 100 can store the historical device attributes 604 corresponding to non-sensitive information for a period of time based on system need. For instance, the device identification system 100 can store the historical device attributes 604 such as device usage frequency, time zones, hardware configurations, operating system type, device chipset, device storage capacity, or device screen resolution based on system need to identify the client device.

In some embodiments, the device identification system 100 can store the historical device attributes 604 based on the sensitivity of the attributes. For example, the device identification system 100 can store sensitive information (e.g., PII) based on the security and time requirements of data retention policies and/or compliance frameworks. In some cases, the device identification system 100 can store one or more of the historical device attributes 604 by anonymizing sensitive data. For example, the device identification system 100 can uniquely identify the client device can using hashed, pseudonymized, or encrypted identifiers for the historical device attributes 604 instead of sensitive identifiers such as MAC addresses or IP addresses.

In some cases, the device identification system 100 utilizes cookies to align interactions (e.g., client devices) with known universal device identifications. For example, by filtering the device attributes to only include requests with valid cookies, the device identification system 100 ensures that the dataset of the historical device attributes 604 is based on reliable, verifiable device interactions. To illustrate, for device attributes that remain consistent across device interactions with the same cookie, the device identification system 100 can use the device attributes for the historical device attributes 604.

As further shown in FIG. 6, the device identification system 100 further utilizes a machine learning device identification model 608. For example, as used herein the machine learning device identification model 608 includes or refers to a machine learning model such as a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks).

As shown in FIG. 6, the device identification system 100 generates identification scores by processing the device attributes 602, the historical device attributes 604, and the stored device attributes 606. In one or more embodiments, the device identification system 100 leverages predictions of the machine learning device identification model 608 to determine whether the universal device identification 614 is associated with a client device. For example, the machine learning predictions can include the identification scores 610 which characterize the comparison between the device attributes 602 extracted from the client device and the stored device attributes of the universal device identification 614.

Based on the identification scores 610, the device identification system 100 determines a universal device identification for a client device. For example, based on the identification scores 610 for the stored device attributes 606 of the universal device identification 614 satisfying a threshold score 612, the device identification system 100 selects the universal device identification 614. If the identification scores for the stored device attributes 606 of the universal device identification 614 fail to satisfy the threshold score 612, the device identification system 100 does not select the universal device identification 614 for the client device.

In one or more embodiments, when the identification scores for the stored device attributes 606 fail to satisfy the threshold score 612, the device identification system 100 does not associated the client device with an existing universal device identification. In some cases, when the identification scores for the stored device attributes 606 fail to satisfy the threshold score 612, the device identification system 100 implements the cascaded identification model 616 to extract additional device attributes (as described in relation to FIG. 5). In some cases, when the identification scores for the stored device attributes 606 fail to satisfy the threshold score 612, the device identification system 100 generates a new universal device identification 618.

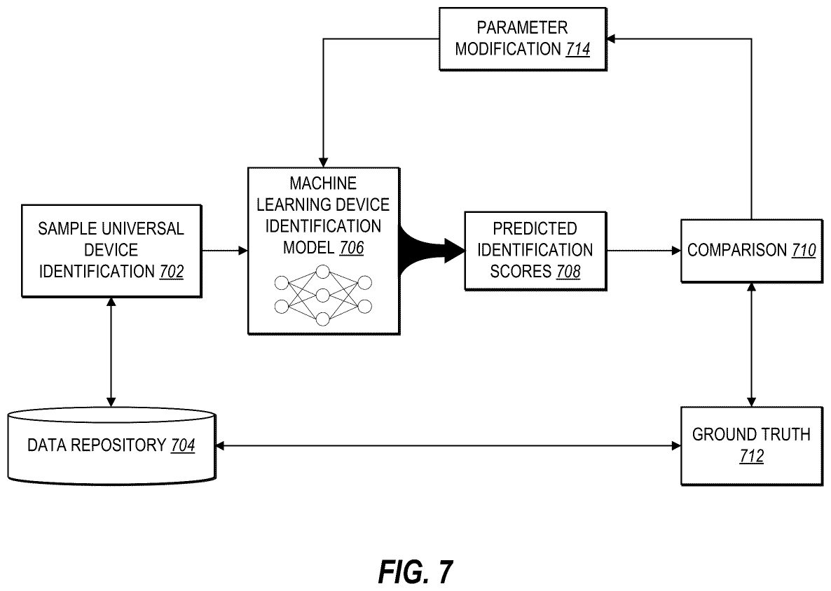

In some cases, the device identification system 100 trains the machine learning device identification model 608 by updating internal parameters such as weight and biases for generating predicted identification scores based on training data. FIG. 7 illustrates an example of training a machine learning device identification model to predict identification scores for a universal device identification in accordance with one or more embodiments.

As shown, the device identification system 100 accesses a sample universal device identification 702 from a data repository 704 to train a machine learning device identification model 706. For example, the device identification system 100 provides the sample universal device identification 702 as sample device attribute input for the machine learning device identification model 706. In some embodiments, the device identification system 100 utilizes the machine learning device identification model 706 to generate the predicted identification scores 708 from the sample universal device identification 702. Specifically, the machine learning device identification model 706 generates the predicted identification scores 708 according to internal parameters.

As part of training the machine learning device identification model 706, the device identification system 100 performs a comparison 710. Specifically, the device identification system 100 compares the predicted identification scores 708 with a ground truth 712 (e.g., a ground truth identification score). In some cases, the device identification system 100 accesses the ground truth 712 from the data repository 704, where the ground truth 712 is designated as corresponding to the sample universal device identification 702. In some cases, the device identification system 100 performs the comparison 710 using a loss function such as a mean squared error loss function or a cross entropy loss function to determine an error or a measure of loss associated with the machine learning device identification model 706 (or between the predicted identification scores 708 and the ground truth 712).

In one or more embodiments, the device identification system 100 further performs a parameter modification 714. Based on the comparison 710, the device identification system 100 modifies parameters of the machine learning device identification model 706. For example, the device identification system 100 modifies parameters of the machine learning device identification model 706 to reduce a measure of error or a loss associated with the machine learning device identification model 706. The device identification system 100 can further repeat the process illustrated in FIG. 7 for many iterations or epochs until the machine learning device identification model 706 satisfies a threshold measure of loss. For each iteration, the device identification system 100 generates new predictions from a new sample universal device identification, performs a comparison, and modifies parameters (e.g., via back propagation) to improve predictions for subsequent iterations.

In some cases, the device identification system 100 trains the machine learning device identification model 706 as described above utilizing historical data. In some cases, the device identification system 100 selects the sample universal device identification 702 and the ground truth 712 based on historical data to train the machine learning device identification model 706. For example, the device identification system 100 selects the sample universal device identification 702 and the ground truth 712 from historical client device interactions to establish baselines for normal client device attributes. In some cases, the device identification system 100 utilizes cookies to align client device interactions (e.g., client devices) with known universal device identifications. For example, by training the machine learning device identification model 706 utilizing universal device identifications from requests with valid cookies, the device identification system 100 ensures that the ground truth 712 is based on reliable, verifiable device interactions.

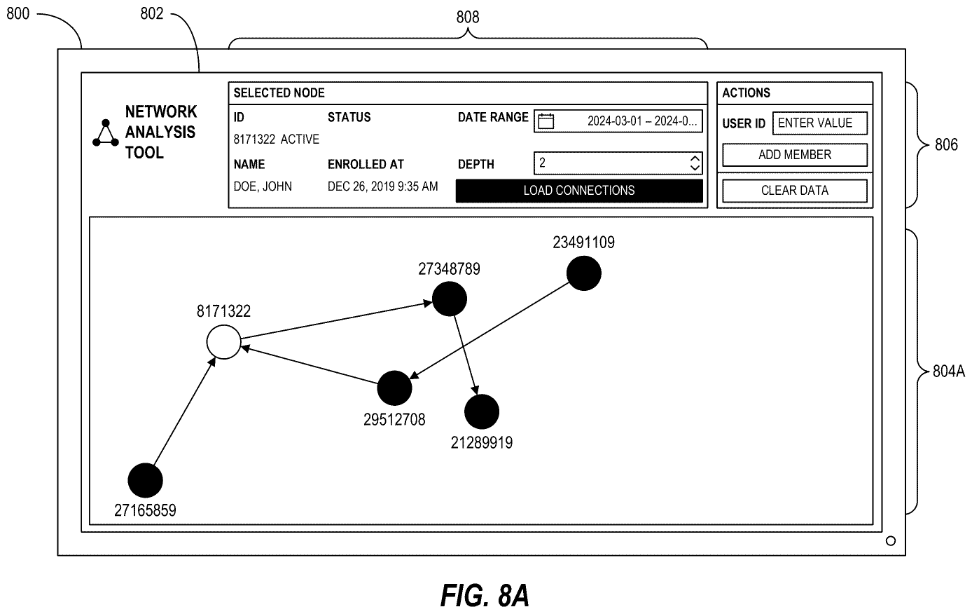

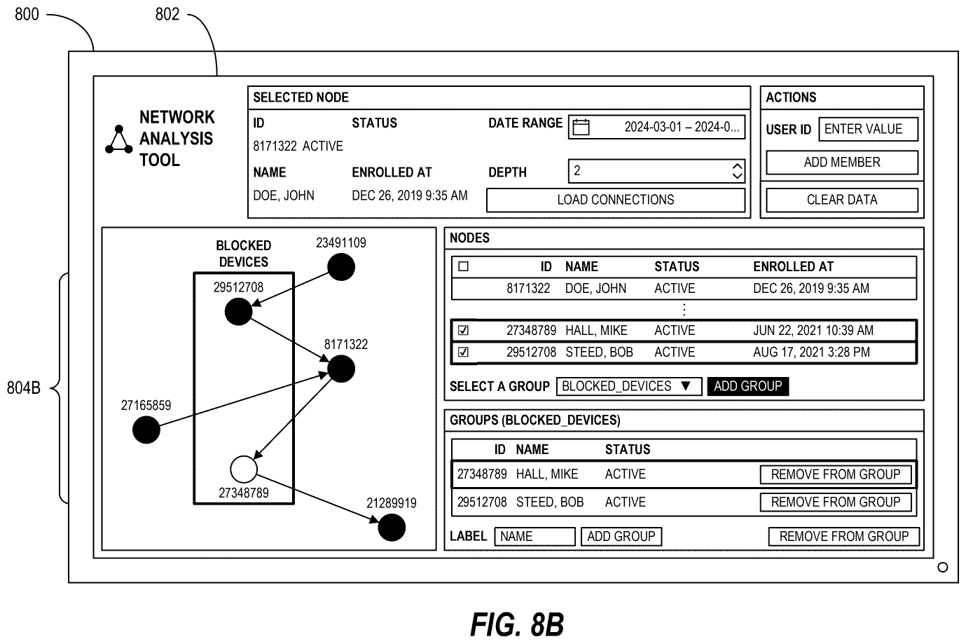

As mentioned, the device identification system 100 generates device insights associated with client devices. FIG. 8A illustrates an example graphical user interface of the device identification system providing device insights for a network graph utilizing universal device identifications in accordance with one or more embodiments.

As shown, the device identification system 100 provides device insights for display on a graphical user interface 802 of an administrator device 800. In some embodiments, the device identification system 100 provides the device insights as a network graph 804A incorporating nodes and edges from the universal device identifications. For example, the device identification system 100 can generate node types representing client devices, user accounts, and/or IP addresses (e.g., selection 806). In some cases, the device identification system 100 associates the nodes with attributes such as trust scores for device reliability, timestamps for device interactions, and/or risk signals associated with client devices. Furthermore, the device identification system 100 can generate edges associated with interactions for the client devices, the user accounts, and/or the IP addresses. In some cases, the device identification system 100 associates edges with (or generates edges based on) attributes such as authentication values for client device interactions with applications, interaction types for client device interactions, frequency counts for client device interactions, or risk indicators for client device interactions.

To illustrate, the device identification system 100 can provide the network graph 804A to clarify various relationships based on universal device identifications. For example, the device identification system 100 can illustrate relationships such as user accounts that have accessed an application on a client device, client devices associated with a user account, or IP addresses a client device has utilized. As also shown, the device identification system 100 can refine the network graph 804A to represent interactions based on an interaction timeframe or a relationship depth or timeframe (e.g., selection 808).

Furthermore, the device identification system 100 can provide tools within a graphical user interface to manage client devices via the network graph. For example, FIG. 8B illustrates an example graphical user interface of the device identification system utilizing a network graph to manage client devices in accordance with one or more embodiments.

As shown in FIG. 8B, the device identification system 100 can provide tools to manage client devices via the network graph 804B. For example, the device identification system 100 can provide tools to select and/or group nodes of the network graph 804B. In addition, the device identification system 100 can provide tools to perform actions on the nodes of the network graph 804B. As illustrated in FIG. 8B, the device identification system 100 can provide tools to group selected client devices (e.g., device 29512708, device 27348789) and block access to the inter-network facilitation system 120 for the selected client devices.

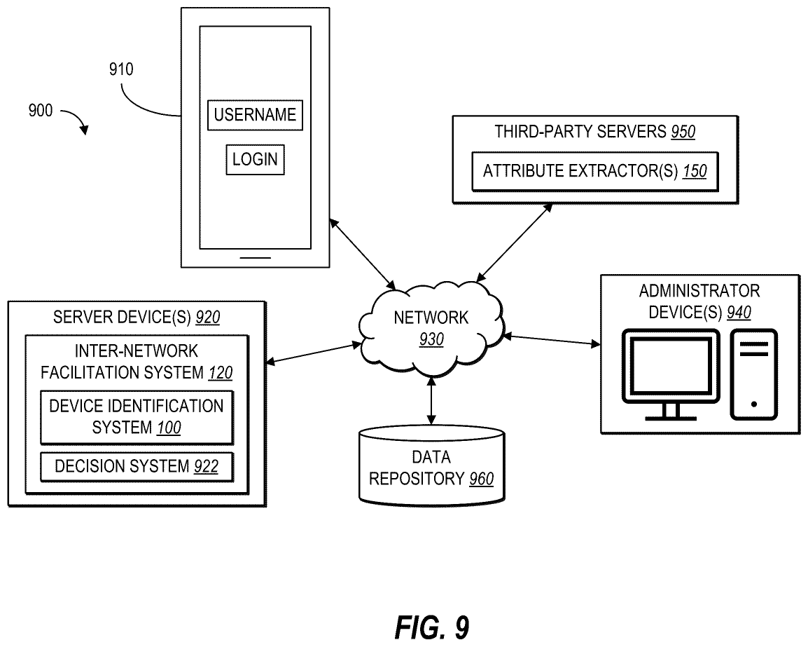

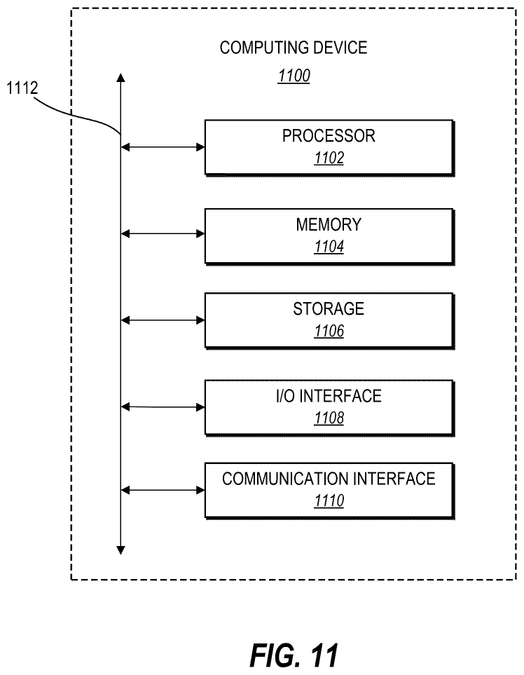

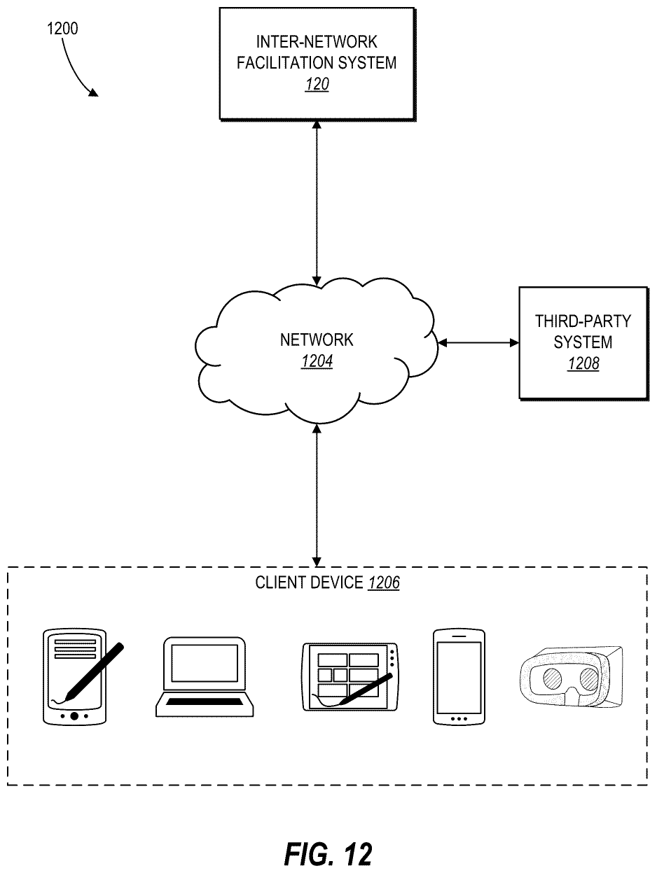

Additional detail regarding the device identification system 100 will now be provided with reference to the above figures. In particular, FIG. 9 illustrates a block diagram of a system environment for implementing the device identification system 100 in accordance with one or more embodiments. As shown in FIG. 9, the environment includes server device(s) 920 implementing the device identification system 100 as part of the inter-network facilitation system 120. The environment of FIG. 9 further includes a client device 910, administrator device(s) 940, a network 930, a decision system 922, and a data repository 960. The server device(s) 920 can include one or more computing devices to implement the device identification system 100. Additional description regarding the illustrated computing devices (e.g., server device(s) 920, the client device 910, the administrator device(s) 940, the network 930, and the data repository 960) is provided with respect to FIGS. 11-12 below.

As described in greater detail below (e.g., in relation to FIG. 11), the inter-network facilitation system 120 can manage interactions across multiple devices, providers, and computer systems. For example, the inter-network facilitation system 120 can execute transactions across various third-party systems such as a banking entity, automated transaction machines, or payment providers. The inter-network facilitation system 120 can also maintain and manage digital accounts for client devices/users to store, manage, and/or transfer funds to other users.

As shown, the device identification system 100 utilizes the network 930 to communicate with the client device 910. The network 930 may comprise a network as described in relation to FIGS. 11-12. For example, the device identification system 100 communicates with the client device 910 to provide and receive information pertaining to various digital transactions or client device interactions with the inter-network facilitation system 120. Indeed, the device identification system 100 can determine a universal device identification for the client device 910.

In some embodiments, the device identification system 100 authenticates a user account to allow the user account to access the inter-network facilitation system 120 via the client device 910. For example, the device identification system 100 accesses account information by accessing a user account associated with the inter-network facilitation system 120. In one or more embodiments, a user account refers to a digital profile associated with the device identification system 100 that allows a client device 910 to access services, data, or functionalities native to the inter-network facilitation system 120. Moreover, a user account can utilize one or more of the client device 910 associated with one or more universal device identifications to access the inter-network facilitation system 120.

Although not a requirement, in one or more embodiments, the device identification system 100 can be part of the inter-network facilitation system 120. Accordingly, as shown in FIG. 9, the server device(s) 920 hosts the inter-network facilitation system 120, which includes the decision system 922. In one or more embodiments, the device identification system 100 collects various types of data, including data provided by the third-party servers 950 (e.g., utilizing the attribute extractor(s) 150). Further, in some embodiments, the device identification system 100 receives and utilizes data from the client device 910. Additionally, the server device(s) 920 can receive data via the network 930 from the data repository 960, the administrator device(s) 940, or from another source.

To facilitate managing and determining universal device identifications for the inter-network facilitation system 120, in some embodiments, the device identification system 100 communicates with the administrator device(s) 940. In particular, the device identification system 100 determines the identity of the client device 910 and provides the universal device identification and/or additional device insights to the administrator device(s) 940. In some embodiments, the device identification system 100 can determine the universal device identification of the client device 910 prior to the inter-network facilitation system 120 disclosing secure information to the client device 910. For example, the device identification system 100 provides universal device identifications (e.g., maintained on the server device(s) 920 and/or the data repository 960) to the inter-network facilitation system 120, and the inter-network facilitation system 120 further allows the client device 910 to access features of the inter-network facilitation system 120.

As mentioned above, the client device 910 includes a device application. In particular, the device application can include a web application, a native application installed on the client device 910 (e.g., a mobile application, a desktop application, etc.), or a cloud-based application where all or part of the functionality is performed by the server device(s) 920. In some embodiments, the inter-network facilitation system 120 or the device identification system 100 communicates with the client device 910 through the device application. This communication for example, receives and provides account information, interaction information, and client device information (including client device attributes).

Although FIG. 9 illustrates the environment having a particular number and arrangement of components associated with device identification system 100, in some embodiments, the environment may include more or fewer components with varying configurations. For example, in some embodiments, the inter-network facilitation system 120 or the device identification system 100 can communicate directly with the client device 910, the third-party servers 950, the administrator device(s) 940, and/or the data repository 960, bypassing the network 930. In these or other embodiments, the inter-network facilitation system 120 or the device identification system 100 can be housed (entirely or in part) on the client device 910. Additionally, the inter-network facilitation system 120 or the device identification system 100 can include or communicate with a data repository 960 for storing information regarding the client device 910. Further, the inter-network facilitation system 120 can include more network components communicatively coupled together.

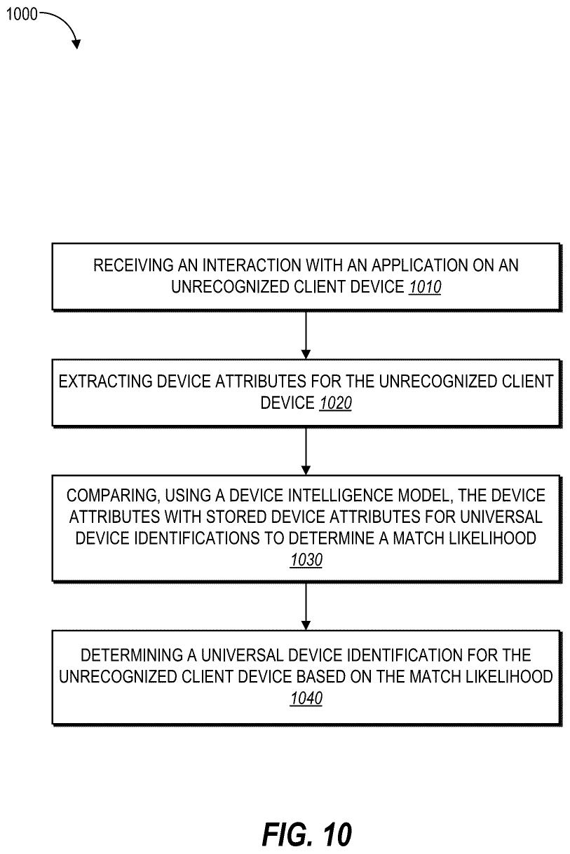

FIGS. 1-9, the corresponding text, and the examples provide a number of different systems, methods, and non-transitory computer readable media for registering client devices by associating the client devices with universal device identifications. In addition to the foregoing, embodiments can also be described in terms of flowcharts comprising acts for accomplishing a particular result. For example, FIG. 10 illustrates a flowchart of an example sequence of acts in accordance with one or more embodiments.

While FIG. 10 illustrates acts according to some embodiments, alternative embodiments may omit, add to, reorder, and/or modify any of the acts shown in FIG. 10. The acts of FIG. 10 can be performed as part of a method. Alternatively, a non-transitory computer readable medium can comprise instructions, that when executed by one or more processors, cause a computing device to perform the acts of FIG. 10. In still further embodiments, a system can perform the acts of FIG. 10. Additionally, the acts described herein may be repeated or performed in parallel with one another or in parallel with different instances of the same or other similar acts.

FIG. 10 illustrates an example series of acts 1000 for determining a universal device identification for an unrecognized client device based on comparing device attributes with stored device attributes of universal device identifications. The series of acts 1000 can include an act 1010 of receiving an interaction with an application on an unrecognized client device. In particular, the act 1010 further includes receiving, at a device identification system of an inter-network facilitation system 120, an interaction with an application on an unrecognized client device. Further, the series of acts 1000 can include an act 1020 of extracting device attributes for the unrecognized client device. In particular, the act 1020 further includes extracting, based on the interaction with the application and using the device identification system, one or more device attributes for the unrecognized client device. Moreover, the series of acts 1000 can include an act 1030 of comparing, using a device identification model, the device attributes with stored device attributes for universal device identifications do determine a match likelihood. In particular, the act 1030 further includes comparing, using a device identification model of the device identification system, the one or more device attributes with stored device attributes for a plurality of universal device identifications maintained within the device identification system. Additionally, the series of acts 1000 can include an act 1040 of determining a universal device identification for the unrecognized client device based the match likelihood. In particular, the act 1040 further includes determining, from among the plurality of universal device identifications, a universal device identification for the unrecognized client device based on comparing the one or more device attributes with the stored device attributes.

In one or more embodiments, the series of acts 1000 includes an act of extracting the one or more device attributes comprises extracting at least a device manufacturer and a device model for the unrecognized client device. Furthermore, in one or more embodiments, the series of acts 1000 includes an act of determining the universal device identification comprises determining, from among the plurality of universal device identifications, a stored attribute bundle including a manufacturer identification matching the device manufacturer and a model identification matching the device model of the unrecognized client device.

Moreover, in one or more embodiments, the series of acts 1000 includes an act of determining the universal device identification comprises utilizing a cascaded identification model to determine, for the plurality of universal device identifications, a first set of identification scores associated with the unrecognized client device based on comparing the one or more device attributes with the stored device attributes. In one or more embodiments, the series of acts 1000 includes an act of determining the universal device identification comprises utilizing the cascaded identification model to determine that the first set of identification scores for the plurality of universal device identifications fail to satisfy a threshold score. Furthermore, in one or more embodiments, the series of acts 1000 includes an act of determining the universal device identification comprises utilizing the cascaded identification model and based on determining that the first set of identification scores fail to satisfy the threshold score, extract, using an attribute extractor, one or more additional device attributes for the unrecognized client device. Moreover, in one or more embodiments, the series of acts 1000 includes an act of determining the universal device identification comprises utilizing the cascaded identification model to determine, for the plurality of universal device identifications, a second set identification scores associated with the unrecognized client device based on comparing the one or more additional device attributes with the stored device attributes.

In one or more embodiments, the series of acts 1000 includes an act of generating a stored attribute bundle by aggregating a first set of device attributes from a first attribute extractor and a second set of device attributes from a second attribute extractor. Furthermore, in one or more embodiments, the series of acts 1000 includes an act of determining an identification score for the unrecognized client device by associating a device attribute from the one or more device attributes with a stored device attribute of the stored device attributes. Moreover, in one or more embodiments, the series of acts 1000 includes an act of determining that the identification score satisfies a threshold score indicating with at least a threshold confidence that the unrecognized client device has previously accessed the inter-network facilitation system 120.

Further, in one or more embodiments, the series of acts 1000 includes an act of determining, for the plurality of universal device identifications, a set of identification scores associated with the unrecognized client device based on comparing the one or more device attributes with the stored device attributes.

Moreover, in one or more embodiments, the series of acts 1000 includes an act of selecting, based on determining that the set of identification scores fail to satisfy a threshold score, a machine learning device identification model. Further, in one or more embodiments, the series of acts 1000 includes an act of determining, utilizing the machine learning device identification model, the universal device identification for the unrecognized client device based on the one or more device attributes, historical device attributes, and the stored device attributes.

In one or more embodiments, the series of acts 1000 includes an act of generating, for a network graph, a node associated with the unrecognized client device. Moreover, in one or more embodiments, the series of acts 1000 includes an act of generating, for the network graph and connected to the node, an edge associated with an authentication value for the interaction with the application on the unrecognized client device. In one or more embodiments, the series of acts 1000 includes an act of providing, for display on an administration device, the network graph comprising the node and the edge.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 11 illustrates, in block diagram form, an exemplary instance of the computing device 1100 (e.g., the client device 910, the server device(s) 920, or the administrator device(s) 940) that may be configured to perform one or more of the processes described above. As shown by FIG. 11, the computing device can comprise a processor 1102, memory 1104, a storage 1106, an I/O interface 1108, and a communication interface 1110. In certain embodiments, the computing device 1100 can include fewer or more components than those shown in FIG. 11. Components of computing device 1100 shown in FIG. 11 will now be described in additional detail.

In particular embodiments, processor 1102 includes hardware for executing instructions, such as those making up a computer program. As an example, and not by way of limitation, to execute instructions, processor 1102 may retrieve (or fetch) the instructions from an internal register, an internal cache, memory 1104, or a storage 1106 and decode and execute them.

The computing device 1100 includes memory 1104, which is coupled to the processor 1102. The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1104 may be internal or distributed memory.

The computing device 1100 includes a storage 1106 includes storage for storing data or instructions. As an example, and not by way of limitation, storage 1106 can comprise a non-transitory storage medium described above. The storage 1106 may include a hard disk drive (“HDD”), flash memory, a Universal Serial Bus (“USB”) drive or a combination of these or other storage devices.

The computing device 1100 also includes one or I/O interface 1108 (or “input or output interface”), which are provided to allow a user (e.g., requester or provider) to provide input to (such as user strokes), receive output from, and otherwise transfer data to and from the computing device 1100. These I/O interface 1108 may include a mouse, keypad or a keyboard, a touch screen, camera, optical scanner, network interface, modem, other known I/O devices or a combination of such I/O interface 1108. The touch screen may be activated with a stylus or a finger.

The I/O interface 1108 may include one or more devices for presenting output to a user, including, but not limited to, a graphics engine, a display (e.g., a display screen), one or more output providers (e.g., display providers), one or more audio speakers, and one or more audio providers. In certain embodiments, I/O interface 1108 is configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 can provide one or more interfaces for communication (such as, for example, packet-based communication) between the computing device and one or more other computing devices 900 or one or more networks. As an example, and not by way of limitation, communication interface 1110 may include a network interface controller (“NIC”) or network adapter for communicating with an Ethernet or other wire-based network or a wireless NIC (“WNIC”) or wireless adapter for communicating with a wireless network, such as a WI-FI. The computing device 1100 can further include a bus 1112. The bus 1112 can comprise hardware, software, or both that connects components of computing device 1100 to each other.

FIG. 12 illustrates an example network environment 1200 of the inter-network facilitation system 120. The network environment 1200 includes a client device 1206 (e.g., client device 910), an inter-network facilitation system 120, and a third-party system 1208 connected to each other by a network 1204. Although FIG. 12 illustrates a particular arrangement of the client device 1206, the inter-network facilitation system 120, the third-party system 1208, and the network 1204, this disclosure contemplates any suitable arrangement of the client device 1206, the inter-network facilitation system 120, the third-party system 1208, and the network 1204. As an example, and not by way of limitation, two or more of the client device 1206, the inter-network facilitation system 120, and the third-party system 1208 communicate directly, bypassing the network 1204. As another example, two or more of the client device 1206, the inter-network facilitation system 120, and the third-party system 1208 may be physically or logically co-located with each other in whole or in part.

Moreover, although FIG. 12 illustrates a particular number of the client device 1206, inter-network facilitation system 120, the third-party system 1208, and the network 1204, this disclosure contemplates any suitable number of the client device 1206, the inter-network facilitation system 120, the third-party system 1208, and the network 1204. As an example, and not by way of limitation, network environment 1200 may include multiple of the client device 1206, the inter-network facilitation system 120, the third-party system 1208, and/or the network 1204.

This disclosure contemplates any suitable network for the network 1204. As an example, and not by way of limitation, one or more portions of the network 1204 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 1204 may include one or more of the network 1204.

Links may connect the client device 1206 and the third-party system 1208 to the network 1204 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1200. One or more first links may differ in one or more respects from one or more second links.

In particular embodiments, the client device 1206 may be an electronic device including hardware, software, or embedded logic components or a combination of two or more such components and capable of carrying out the appropriate functionalities implemented or supported by the client device 1206. As an example, and not by way of limitation, the client device 1206 may include any of the computing devices discussed above in relation to FIG. 12. The client device 1206 may enable a network user at the client device 1206 to access the network 1204. The client device 1206 may enable its user to communicate with other users at other of the client device 1206.

In particular embodiments, the client device 1206 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1206 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1206 one or more Hyper Text Markup Language (“HTML”) files responsive to the HTTP request. The client device 1206 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 120 may be a network-addressable computing system that can interface between two or more computing networks or servers associated with different entities such as financial institutions (e.g., banks, credit processing systems, ATM systems, or others). In particular, the inter-network facilitation system 120 can send and receive network communications (e.g., via the network 1204) to link the third-party system 1208. For example, the inter-network facilitation system 120 may receive authentication credentials from a user to link the third-party system 1208 such as an online bank account, credit account, debit account, or other financial account to a user account within the inter-network facilitation system 120. The inter-network facilitation system 120 can subsequently communicate with the third-party system 1208 to detect or identify balances, transactions, withdrawal, transfers, deposits, credits, debits, or other transaction types associated with the third-party system 1208. The inter-network facilitation system 120 can further provide the aforementioned or other financial information associated with the third-party system 1208 for display via the client device 1206. In some cases, the inter-network facilitation system 120 links more than one of the third-party system 1208, receiving account information for accounts associated with each respective instance of the third-party system 1208 and performing operations or transactions between the different systems via authorized network connections.

In particular embodiments, the inter-network facilitation system 120 may interface between an online banking system and a credit processing system via the network 1204. For example, the inter-network facilitation system 120 can provide access to a bank account of the third-party system 1208 and linked to a user account within the inter-network facilitation system 120. Indeed, the inter-network facilitation system 120 can facilitate access to, and transactions to and from, the bank account of the third-party system 1208 via a client application of the inter-network facilitation system 120 on the client device 1206. The inter-network facilitation system 120 can also communicate with a credit processing system, an ATM system, and/or other financial systems (e.g., via the network 1204) to authorize and process credit charges to a credit account, perform ATM transactions, perform transfers (or other transactions) across accounts of different instances of the third-party system 1208, and to present corresponding information via the client device 1206.

In particular embodiments, the inter-network facilitation system 120 includes a model for approving or denying transactions. For example, the inter-network facilitation system 120 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data packets (from the inter-network facilitation system 120 and/or one or more third-party systems), the inter-network facilitation system 120 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 120 may be accessed by the other components of network environment 1200 either directly or via network 1204. In particular embodiments, the inter-network facilitation system 120 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 120 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device 1206, or the inter-network facilitation system 120 to manage, retrieve, modify, add, or delete, the information stored in data store.

In particular embodiments, the inter-network facilitation system 120 may provide users with the ability to take actions on various types of items or objects, supported by the inter-network facilitation system 120. As an example, and not by way of limitation, the items and objects may include financial institution networks for banking, credit processing, or other transactions, to which users of the inter-network facilitation system 120 may belong, computer-based applications that a user may use, transactions, interactions that a user may perform, or other suitable items or objects. A user may interact with anything that is capable of being represented in the inter-network facilitation system 120 or by an external system of a third-party system, which is separate from inter-network facilitation system 120 and coupled to the inter-network facilitation system 120 via a network 1204.

In particular embodiments, the inter-network facilitation system 120 may be capable of linking a variety of entities. As an example, and not by way of limitation, the inter-network facilitation system 120 may enable users to interact with each other or other entities, or to allow users to interact with these entities through an application programming interfaces (“API”) or other communication channels.

In particular embodiments, the inter-network facilitation system 120 may include a variety of servers, sub-systems, programs, modules, logs, and data stores. In particular embodiments, the inter-network facilitation system 120 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 120 may also include suitable components such as network interfaces, security mechanisms, load balancers, failover servers, management-and-network-operations consoles, other suitable components, or any suitable combination thereof. In particular embodiments, the inter-network facilitation system 120 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 120 and one or more of the client device 1206. An action logger may be used to receive communications from a web server about a user's actions on or off the inter-network facilitation system 120. In conjunction with the action log, a third-party-content-object log may be maintained of user exposures to third-party-content objects. A notification controller may provide information regarding content objects to the client device 1206. Information may be pushed to the client device 1206 as notifications, or information may be pulled from the client device 1206 responsive to a request received from the client device 1206. Authorization servers may be used to enforce one or more privacy settings of the users of the inter-network facilitation system 120. A privacy setting of a user determines how particular information associated with a user can be shared. The authorization server may allow users to opt in to or opt out of having their actions logged by the inter-network facilitation system 120 or shared with other systems, such as, for example, by setting appropriate privacy settings. Third-party-content-object stores may be used to store content objects received from third parties. Location stores may be used for storing location information received from the client device 1206 associated with users.

In addition, the third-party system 1208 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 120 via the network 1204. The third-party system 1208 can communicate with the inter-network facilitation system 120 to provide financial information pertaining to balances, transactions, and other information, whereupon the inter-network facilitation system 120 can provide corresponding information for display via the client device 1206. In particular embodiments, the third-party system 1208 communicates with the inter-network facilitation system 120 to update account balances, transaction histories, credit usage, and other internal information of the inter-network facilitation system 120 and/or the third-party system 1208 based on user interaction with the inter-network facilitation system 120 (e.g., via the client device 1206). Indeed, the inter-network facilitation system 120 can synchronize information across one or more third-party systems to reflect accurate account information (e.g., balances, transactions, etc.) across one or more networked systems, including instances where a transaction (e.g., a transfer) from one of the third-party system 1208 affects another of the third-party system 1208.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving, at a device identification system of an inter-network facilitation system, an interaction with an application on an unrecognized client device;
extracting, based on the interaction with the application and using the device identification system, one or more device attributes for the unrecognized client device;
comparing, using a device identification model of the device identification system, the one or more device attributes with stored device attributes for a plurality of universal device identifications maintained within the device identification system; and
determining, from among the plurality of universal device identifications, a universal device identification for the unrecognized client device based on comparing the one or more device attributes with the stored device attributes.

2. The computer-implemented method of claim 1, wherein:
extracting the one or more device attributes comprises extracting at least a device manufacturer and a device model for the unrecognized client device; and
determining the universal device identification comprises determining, from among the plurality of universal device identifications, a stored attribute bundle including a manufacturer identification matching the device manufacturer and a model identification matching the device model of the unrecognized client device.

3. The computer-implemented method of claim 1, wherein the device identification model comprises a cascaded identification model and determining the universal device identification comprises utilizing the cascaded identification model to:
determine, for the plurality of universal device identifications, a first set of identification scores associated with the unrecognized client device based on comparing the one or more device attributes with the stored device attributes;
determine that the first set of identification scores for the plurality of universal device identifications fail to satisfy a threshold score;
based on determining that the first set of identification scores fail to satisfy the threshold score, extract, using an attribute extractor, one or more additional device attributes for the unrecognized client device; and
determine, for the plurality of universal device identifications, a second set identification scores associated with the unrecognized client device based on comparing the one or more additional device attributes with the stored device attributes.

4. The computer-implemented method of claim 1, wherein determining the universal device identification for the unrecognized client device comprises generating a stored attribute bundle by aggregating a first set of device attributes from a first attribute extractor and a second set of device attributes from a second attribute extractor.

5. The computer-implemented method of claim 1, wherein determining the universal device identification for the unrecognized client device comprises:
determining an identification score for the unrecognized client device by associating a device attribute from the one or more device attributes with a stored device attribute of the stored device attributes; and
determining that the identification score satisfies a threshold score indicating with at least a threshold confidence that the unrecognized client device has previously accessed the inter-network facilitation system.

6. The computer-implemented method of claim 1, further comprising:
determine, for the plurality of universal device identifications, a set of identification scores associated with the unrecognized client device based on comparing the one or more device attributes with the stored device attributes;
select, based on determining that the set of identification scores fail to satisfy a threshold score, a machine learning device identification model; and
determine, utilizing the machine learning device identification model, the universal device identification for the unrecognized client device based on the one or more device attributes, historical device attributes, and the stored device attributes.

7. The computer-implemented method of claim 1, further comprising:
generating, for a network graph, a node associated with the unrecognized client device;
generating, for the network graph and connected to the node, an edge associated with an authentication value for the interaction with the application on the unrecognized client device; and
providing, for display on an administration device, the network graph comprising the node and the edge.

8. A system comprising:
at least one processor; and
a non-transitory computer readable medium storing instructions that, when executed by the at least one processor, cause the system to:
receive, at a device identification system of an inter-network facilitation system, an interaction with an application on an unrecognized client device;
extract, based on the interaction with the application and using the device identification system, one or more device attributes for the unrecognized client device;
compare, via a device identification model of the device identification system, the one or more device attributes with stored device attributes for a plurality of universal device identifications maintained within the device identification system; and
determine, from among the plurality of universal device identifications, a universal device identification for the unrecognized client device based on a comparison of the one or more device attributes with the stored device attributes.

9. The system of claim 8, wherein the non-transitory computer readable medium stores further instructions that, when executed by the at least one processor, cause the system to:
extract, for the one or more device attributes, at least a device manufacturer and a device model for the unrecognized client device; and
determine, for the universal device identification from among the plurality of universal device identifications, a stored attribute bundle including a manufacturer identification matching the device manufacturer and a model identification matching the device model of the unrecognized client device.

10. The system of claim 8, wherein the device identification model comprises a cascaded identification model and determine the universal device identification comprises utilize the cascaded identification model to:
determine, for the plurality of universal device identifications, a first set of identification scores associated with the unrecognized client device based on the comparison of the one or more device attributes with the stored device attributes;
determine that the first set of identification scores for the plurality of universal device identifications fail to satisfy a threshold score;
based on a determination that the first set of identification scores fail to satisfy the threshold score, extract, via an attribute extractor, one or more additional device attributes for the unrecognized client device; and
determine, for the plurality of universal device identifications, a second set identification scores associated with the unrecognized client device based on the comparison of the one or more additional device attributes with the stored device attributes.

11. The system of claim 8, wherein the non-transitory computer readable medium stores further instructions that, when executed by the at least one processor, cause the system to determine, for the universal device identification for the unrecognized client device, a stored attribute bundle by an aggregation of a first set of device attributes from a first attribute extractor and a second set of device attributes from a second attribute extractor.

12. The system of claim 8, wherein the non-transitory computer readable medium stores further instructions that, when executed by the at least one processor, cause the system to:
determine, for the universal device identification for the unrecognized client device, an identification score for the unrecognized client device through an association of a device attribute from the one or more device attributes with a stored device attribute of the stored device attributes; and
determine that the identification score satisfies a threshold score indicating with at least a threshold confidence that the unrecognized client device has previously accessed the inter-network facilitation system.

13. The system of claim 8, further storing instructions that, when executed by the at least one processor, cause the system to:
determine, for the plurality of universal device identifications, a set of identification scores associated with the unrecognized client device based on a comparison of the one or more device attributes with the stored device attributes;
select, based on a determination that the set of identification scores fail to satisfy a threshold score, a machine learning device identification model; and
determine, via the machine learning device identification model, the universal device identification for the unrecognized client device based on the one or more device attributes, historical device attributes, and the stored device attributes.

14. The system of claim 8, further storing instructions that, when executed by the at least one processor, cause the system to:
generate, for a network graph, a node associated with the unrecognized client device;
generate, for the network graph and connected to the node, an edge associated with an authentication value for the interaction with the application on the unrecognized client device; and
generate, for display on an administration device, the network graph comprising the node and the edge.

15. A non-transitory computer readable medium storing instructions that, when executed by at least one processor, cause a computing device to:
receive, at a device identification system of an inter-network facilitation system, an interaction with an application on an unrecognized client device;
extract, based on the interaction with the application and using the device identification system, one or more device attributes for the unrecognized client device;
compare, using a device identification model of the device identification system, the one or more device attributes with stored device attributes for a plurality of universal device identifications maintained within the device identification system; and
determine, from among the plurality of universal device identifications, a universal device identification for the unrecognized client device based on comparing the one or more device attributes with the stored device attributes.

16. The non-transitory computer readable medium of claim 15, wherein:
extracting the one or more device attributes comprises extracting at least a device manufacturer and a device model for the unrecognized client device; and
determining the universal device identification comprises determining, from among the plurality of universal device identifications, a stored attribute bundle including a manufacturer identification matching the device manufacturer and a model identification matching the device model of the unrecognized client device.

17. The non-transitory computer readable medium of claim 15, wherein the device identification model comprises a cascaded identification model and determining the universal device identification comprises utilizing the cascaded identification model to:
determine, for the plurality of universal device identifications, a first set of identification scores associated with the unrecognized client device based on comparing the one or more device attributes with the stored device attributes;
determine that the first set of identification scores for the plurality of universal device identifications fail to satisfy a threshold score;
based on determining that the first set of identification scores fail to satisfy the threshold score, extract, using an attribute extractor, one or more additional device attributes for the unrecognized client device; and
determine, for the plurality of universal device identifications, a second set identification scores associated with the unrecognized client device based on comparing the one or more additional device attributes with the stored device attributes.

18. The non-transitory computer readable medium of claim 15, wherein determining the universal device identification for the unrecognized client device comprises generating a stored attribute bundle by aggregating a first set of device attributes from a first attribute extractor and a second set of device attributes from a second attribute extractor.

19. The non-transitory computer readable medium of claim 15, wherein determining the universal device identification for the unrecognized client device comprises:
determining an identification score for the unrecognized client device by associating a device attribute from the one or more device attributes with a stored device attribute of the stored device attributes; and
determining that the identification score satisfies a threshold score indicating with at least a threshold confidence that the unrecognized client device has previously accessed the inter-network facilitation system.

20. The non-transitory computer readable medium of claim 15, further storing instructions that, when executed by the at least one processor, cause the computing device to:
determine, for the plurality of universal device identifications, a set of identification scores associated with the unrecognized client device based on comparing the one or more device attributes with the stored device attributes;
select, based on determining that the set of identification scores fail to satisfy a threshold score, a machine learning device identification model; and
determine, utilizing the machine learning device identification model, the universal device identification for the unrecognized client device based on the one or more device attributes, historical device attributes, and the stored device attributes.
